(19) United States
(12) Patent Application Publication
(10) Pub. No.: US 2007/0243001 A1
(43) Pub. Date: Oct. 18, 2007

(54) Image Forming Devices

(75) Inventor: Kenji Samoto, Nagoya-shi (JP)

Correspondence Address: BAKER BOTTS LLP;C/O INTELLECTUAL PROPERTY DEPARTMENT, THE WARNER, SUITE 1300, 1299 PENNSYLVANIA AVE, NW, WASHINGTON, DC, 20004-2400, US

(73) Assignee: Brother Kogyo Kabushiki Kaisha, Nagoya-shi (JP)

(21) Appl. No.: 11/694,759

(22) Filed: Mar. 30, 2007

(30) Foreign Application Priority Data
Mar. 31, 2006 (JP) 2006-099875

(51) Int. Cl. B41J 25/304

(52) U.S. Cl. 400/320

(57) ABSTRACT

A carriage transiting device includes a pair of guide rails, a carriage including a carriage body and mounted on the pair of guide rails, a recording head mounted on the carriage body, and a belt drive mechanism disposed along the guide rails to move the carriage back and forth along the guide rails. Each of the pair of guide rails includes a first end and a second end and extending in a predetermined direction from the first end to the second end. The belt drive mechanism includes a drive pulley disposed proximate to the first end of the guide rails that is rotated by a driving force generated by a drive source and including a plurality of spur teeth, a follower pulley disposed proximate to the second end of the guide rails and separate from the drive pulley in the predetermined direction; and a belt disposed about the drive pulley and the follower pulley. The belt moves circumferentially when the drive pulley rotates and may comprise a section of reduced thickness, which section of reduced thickness engages the follower pulley while the carriage moves back and forth over the guide rails, and a plurality of belt teeth. The plurality of belt teeth are disposed outside of the section of reduced thickness and are configured to mesh with the plurality of spur teeth.

### BACKGROUND OF THE INVENTION

This application claims the benefit of Japanese Patent Application No. 2006-099875, filed Mar. 31, 2006, which is incorporated herein by reference.

1. Field of the Invention

The present invention relates to an image formation device comprising a guide rail comprising a guide surface extending in a predetermined direction, a carriage mounted on the guide surface of the guide rail, a recording head mounted on the carriage, and a belt drive mechanism comprising a timing belt extending along the guide rail to move the carriage back and forth along the guide surface when the timing belt is in circumferential motion.

2. Description of Related Art

A known image formation device is a so-called inkjet-type that performs image recording to a recording medium by selectively discharging ink droplets from a recording head for placement on the recording medium. The recording head is mounted on a carriage that is supported by a guide rail or a guide shaft, and is moved back and forth in the direction crossing the direction along which the recording medium is transferred. During such back-and-forth movement, the ink droplets are discharged selectively from the recording head to the recording medium.

The carriage is moved back and forth by a belt drive mechanism including a timing belt. As examples, refer to Japanese Utility Model Registration No. 3,084,505 and Japanese Patent Publication Nos. 2002-178586A, 2001-071463A, and 2005-313492A. For example, when a timing belt is placed across two pulleys, and the timing belt is coupled with a carriage. The pulleys are rotated in response to a driving force generated by a drive source such as a motor. In this case, when the pulleys are rotated, the timing belt is put in circumferential motion about the two pulleys. This circumferential motion accordingly moves, back and forth on the guide rail; the carriage fixedly coupled to the timing belt.

Referring to the two pulleys of the belt drive mechanism, one of the pulleys receiving the driving force generated by the drive source, i.e., drive pulley, may be toothed, and the other pulley, i.e., follower pulley, may be toothless. Through tooth meshing between the drive pulley and the timing belt, the driving force is transferred effectively from the drive pulley to the timing belt. Such a configuration, however, may be susceptible to vibration when the timing belt is put in circumferential motion with its teeth coming into contact with the follower pulley. There is another problem of tooth abrasion of the timing belt due to the contact with the follower pulley. As measures against such problems, removal of the teeth of the timing belt from an area coming into contact with the follower pulley for a circumferential motion has been proposed. This proposal is discussed in more detail in Japanese Patent Publication No. H11-314419A.

### SUMMARY OF THE INVENTION

FIG. 31 is a schematic diagram showing a carriage 202 that is moved back-and-forth motion on a guide rail 201 by a belt drive mechanism. Guide rail 201 is of a plate-like material having a substantially-flat upper surface, and supports carriage 202 on the upper surface to make carriage 202 to move back and forth. Guide rail 201 is provided with one of pulleys 203 and 204 at each end, and a timing belt 205 is placed across pulleys 203 and 204. Carriage 202 comprises a grip section 206, which grips the timing belt 205. This gripping enables carriage 202 to be coupled to timing belt 205, and when timing belt 205 is put into circumferential motion, carriage 202 is moved back and forth on guide rail 201.

As shown in FIG. 31, there is a height difference H between timing belt 205 in pulleys 203 and 204 and grip section 206. In particular, grip section 206 grips timing belt 205 at a position elevated by the height difference above timing belt 205 in pulleys 203 and 204. Thus, timing belt 205 is urged away from guide rail 201 by grip section 206, and the tension of timing belt 205 acts in the vertical direction, so that carriage 202 is biased toward guide rail 201. As a result, when carriage 202 moves back and forth, carriage 202 is prevented from being moved upward from guide rail 201, so that the head gap remains the same.

As shown in FIG. 32, height difference H remains the same even if carriage 202 is moved closer to pulley 203. Compared with a case in which carriage 202 is located substantially at the center between pulleys 203 and 204, however, the distance from pulley 203 to grip section 206 is reduced, so that the slope angle of timing belt 205 increases between pulley 203 and grip section 206. As a result, compared with a case in which cartridge 202 is located substantially at the center between pulleys 203 and 204, the biasing force generated in the vertical direction by the tension of timing belt 205 increases when carriage 202 is located closer to pulleys 203 and 204. In other words, when carriage 202 is located in the vicinity of pulleys 203 and 204, the friction is increased between pulleys 203 and 204 and timing belt 205 as compared with a case in which carriage 202 is located substantially at the center between pulleys 203 and 204. This increased friction causes subjects timing belt 205 to uneven abrasion.

The increased friction between pulleys 203 and 204 and timing belt 205, and the increased friction between guide rail 201 and carriage 202 require a motor with a higher torque. This is because the necessary torque of a motor rotating pulleys 203 and 204 is dictated by the portion of the carriage path generating the highest friction, i.e., when carriage 202 is located in the vicinity of pulleys 203 and 204. To reduce the friction for a case in which carriage 202 is located in the vicinity of either of pulleys 203 or 204, pulleys 203 and 204 may be disposed at positions away from the ends at which carriage 202 reaches when it is moved back and forth for the aim of increasing the distance between pulley 203 to grip section 206. Nevertheless, in this configuration, carriage 202 moves more in the direction of moving back and forth, thereby causing another problem by failing to reduce the device size.

The present invention addresses these problems, and an object thereof is to provide, in an image formation device in which a carriage moves back and forth on a guide rail by means of a belt drive mechanism, means for reducing the increase of a vertical biasing force generated by the tension of a timing belt in the vicinity of either of the pulleys.

In an embodiment of this invention, a carriage transiting device may comprise at least one guide rail, a carriage comprising a carriage body and mounted on the at least one guide rail, a recording head mounted on the carriage body, and a belt drive mechanism disposed along the guide rail to move the carriage back and forth along the guide surface. Each of the at least one guide rail may comprise a first end and a second end and extending in a predetermined direction from the first end to the second end. The belt drive mechanism may comprise a drive pulley disposed proximate to the first end of the at least one guide rail that is rotated by a driving force generated by a drive source and comprising a plurality of spur teeth, a follower pulley disposed proximate to the second end of the at least one guide rail and separate from the drive pulley in the predetermined direction; and a belt disposed about the drive pulley and the follower pulley. The belt moves circumferentially when the drive pulley rotates and may comprise a section of reduced thickness section, which section of reduced thickness engages the follower pulley while the carriage moves back and forth over the at least one guide rail, and a plurality of belt teeth. The plurality of belt teeth are disposed outside of the section of reduced thickness and are configured to mesh with the plurality of spur teeth.

In another embodiment of this invention, a carriage transiting device may comprise at least one guide rail, a carriage comprising a carriage body and mounted on the at least one guide rail, a recording head mounted on the carriage body,

and a belt drive mechanism disposed along the guide rail to move the carriage back and forth along the guide surface. Each of the at least one guide rail may comprise a first end and a second end and extending in a predetermined direction from the first end to the second end. The belt drive mechanism may comprise a drive pulley disposed proximate to the first end of the at least one guide rail that is rotated by a driving force generated by a drive source and comprising a plurality of spur teeth, a follower pulley disposed proximate to the second end of the at least one guide rail and separate from the drive pulley in the predetermined direction; and a belt disposed about the drive pulley and the follower pulley. The belt moves circumferentially when the drive pulley rotates, and may comprise a section of reduced thickness section, which section of reduced thickness engages the follower pulley while the carriage moves back and forth over the at least one guide rail, and a plurality of belt teeth. A first average height of the belt teeth disposed outside of the section of reduced thickness is greater than a second average height of the belt teeth disposed within the section of reduced thickness, and the plurality of belt teeth are configured to mesh with the plurality of spur teeth.

In still another embodiment of this invention, a carriage transiting device may comprise at least one guide rail, a carriage comprising a carriage body and mounted on the at least one guide rail, a recording head mounted on the carriage body, a load mechanism that imposes a load on the carriage in a direction away from the guide surface when the drive pulley rotates and the carriage is located proximate to the drive pulley and while the carriage moves back and forth over the at least one guide rail, and a belt drive mechanism disposed along the guide rail to move the carriage back and forth along the guide surface. Each of the at least one guide rail may comprise a first end and a second end and extending in a predetermined direction from the first end to the second end. The belt drive mechanism may comprise a drive pulley disposed proximate to the first end of the at least one guide rail that is rotated by a driving force generated by a drive source and comprising a plurality of spur teeth, a follower pulley disposed proximate to the second end of the at least one guide rail and separate from the drive pulley in the predetermined direction; and a belt disposed about the drive pulley and the follower pulley. The belt moves circumferentially when the drive pulley rotates.

An yet another embodiment of the invention is directed to an image formation device that comprises: a guide rail comprising a guide surface extended in a predetermined direction; a carriage mounted on the guide surface of the guide rail; a recording head mounted on the carriage; and a belt drive mechanism disposed along the guide rail to move the carriage back and forth along the guide surface. In the image formation device, the belt drive mechanism comprises: a drive pulley that is rotated and driven in an axial direction orthogonal to the guide surface in response to a driving force generated by a drive source; a follower pulley disposed distally from the drive pulley in a direction along which the guide surface extends; and a belt disposed across the drive pulley and the follower pulley, and moves in a circumferential direction when the drive pulley rotates. The belt may be formed with a section of reduced thickness within a range of the carriage to move back and forth, but not in a recording area for use by the recording head, and the carriage comprises: a carriage body carrying thereon the recording head; and a belt coupling section disposed at a position at which the carriage body is biased, through coupling with the belt, toward the guide surface by the tension of the belt.

The carriage body carries thereon the recording head. The carriage is supported by the guide rail, and moves back and forth along the guide surface together with the recording head. The carriage receives a driving force from the belt drive mechanism, and starts moving back and forth. The belt drive mechanism is disposed along the guide rail, and has a belt. The belt is placed across the drive pulley and the follower pulley, and moves in circumferential motion in response to the rotation of the drive pulley. The coupling section of the carriage is coupled to the belt. When the coupling section is coupled with the belt, the carriage body is biased toward the guide surface by the tension of the belt.

The biasing force for application to the carriage body is greatest in the vicinity of the drive and follower pulleys, and is lowest at the center between the drive and follower pulleys. This biasing force acts to prevent the carriage from moving away from the guide surface. When exposed to an elevated biasing force, however, the carriage is prevented from moving smoothly, e.g., the carriage produces more friction when sliding in contact with the guide rail. To ensure the smooth back-and-forth movement of the carriage, a recording area in which the recording head performs image recording is designed not to increase the biasing force applied to the carriage body. In particular, the area in the vicinity of the drive and follower pulleys is not used as the recording area, but instead, this area may be used as a home position for the carriage or as a maintenance area for the recording head.

The belt may be formed with a section of reduced thickness within a range of the carriage to move back and forth, but not in a recording area for use by the recording head. In the section of reduced thickness, the belt may be less thick than in the surrounding area. This section is wound around the drive or follower pulley, so that a thickness allowance appears in the direction along which the belt is placed. The thickness allowance here is equal to the thickness reduced by the section of reduced thickness. Such a thickness allowance reduces the tension of the belt, so that the biasing force applied to the carriage body is reduced accordingly in the vicinity of the drive and follower pulleys.

In this embodiment, the drive pulley may be a toothed pulley, the belt may be a toothed belt for meshing with the drive pulley, and the section of reduced thickness may be a portion at which a tooth of the belt is reduced in height or at which a tooth is missing.

Further, the belt may be formed with a taper section that is tapered in thickness at a border between a toothed portion formed with the tooth and the material-thin section. Within this taper section, the belt gently changes in thickness when the section of reduced thickness is wound around the follower pulley. This favorably reduces the shock to the carriage that may occur when the belt changes in thickness.

Moreover, preferably, the section of reduced thickness is formed on the side of the drive pulley and within the range in which the carriage moves back and forth, but not in the recording area used by the recording head.

The meshing between the drive pulley and the belt prevents the belt from slipping on the drive pulley, and, thus, the biasing force applied to the carriage body tends to increase on the drive pulley side. In consideration thereof, with the section of reduced thickness formed on the side of the drive pulley and within the range in which the carriage moves back and forth, but not in the recording area used by the recording head, the maximum biasing force applied to the carriage body may be reduced.

Preferably, a load mechanism imposes a load on the carriage in the direction to move the carriage upward from the guide surface when the drive pulley rotates on the side of the drive pulley within the range in which the carriage moves back and forth, but not in the recording area used by the recording head.

With such a load mechanism, the biasing force applied to the carriage body increases on the drive pulley side to a further extent. Consequently, the invention may effectively reduce the maximum biasing force applied to the carriage body.

The load mechanism may be a capping mechanism that presses a cap to make it tightly contact the recording head.

In another embodiment, the load mechanism may be a gap switching mechanism that changes the height of the carriage with respect to the guide surface.

The gap switching mechanism may comprise: a slide member that slides in contact with the guide rail to support the carriage body at a predetermined height; a support member disposed on the carriage body to support the slide member, so that the slide member moves in a vertical direction; a biasing member that elastically biases the slide member upward; and a gap adjustment member that is disposed between the slide member and the support member to slide in the direction in which the carriage moves back and forth, and that protrudes, from the carriage body at both ends in a sliding direction to change the size or shape a space between the slide member and the support member depending on a slide position.

The gap switching mechanism may be disposed on the carriage body to freely rotate and to support the carriage body at the predetermined height. A rotation axis comprising a plurality of slide-in-contact members is aligned in the circumferential direction with varying protrusion widths projecting outward in the diameter direction by making any of the protrusion-width-varying slide-in-contact members slide into contact with the guide rail.

The follower pulley may slide in the direction away from the drive pulley, and may be elastically biased in the direction which provides tension to the belt.

By the section of reduced thickness being wound around the drive pulley, a thickness allowance equal to the thickness reduced in the section may occur in the direction along which the belt is placed. In response, because the follower pulley may be elastically biased in the direction providing tension to the belt, the follower pulley slides in the direction away from the drive pulley by the amount of the allowance. As the follower pulley so slides, the elastic biasing force reduces, and by extension, the tension of the belt also reduces.

The belt may comprise a mark at the position at which a coupling section of the carriage is coupled.

As described in the foregoing, the belt is formed with the section of reduced thickness at the predetermined position. When the carriage is located within the range in which the carriage moves back and forth, but not in the recording area of reduced thickness used by the recording head, the section is wound around the drive pulley or the follower pulley. Thus, the coupling section of the carriage may be coupled to the belt at such a predetermined position. Because a mark is provided at the position at which the coupling section of the carriage is coupled, a user immediately may know where to couple the coupling section of the carriage, thereby facilitating the assembly operation. To provide such a mark, the belt may be partially colored or marked, or the belt may be changed in appearance, e.g., made uneven.

In an image formation device according to an embodiment of the invention, the belt biasing the carriage body toward the guide surface may comprise the section of reduced thickness within the range in which the carriage moves back and forth, but not in the recording area used by the recording head. This section of reduced thickness may be wound around the drive or follower pulley, so that a thickness allowance equal to the thickness reduced in the section of reduced thickness appears in the direction along which the belt is placed. Such a thickness allowance reduces the tension of the belt, so that the biasing force applied to the carriage body may be reduced accordingly in the vicinity of the drive and follower pulleys. This configuration may prevent uneven abrasion of the belt, and may reduce or eliminate the need to increase the drive source torque. This also enables the carriage to move back and forth between and proximate to each of the drive or follower pulley, thereby achieving reduction of the device size.

Other objects, features, and advantages will be apparent to persons of ordinary skill in the art from the following detailed description of the invention and the accompanying drawings.

### BRIEF DESCRIPTION OF THE DRAWINGS

For a more complete understanding of the present invention, the needs satisfied thereby, and the features and technical advantages thereof, reference now is made to the following descriptions taken in connection with the accompanying drawings.

FIG. 1 is a perspective view of an external configuration of a multi-function device 1 according to an embodiment of the invention.

FIG. 2 is a vertical, cross-sectional view of an internal configuration of multi-function device 1.

FIG. 3 is an enlarged, cross-sectional view of the configuration of a printer section 2.

FIG. 4 is an enlarged, plan view of the configuration of printer section 2.

FIG. 5 is an enlarged, plan view of the configuration of a follower pulley 48 and surrounding components.

FIG. 6 is a plan view of the configuration of a purge mechanism 56.

FIG. 7 is a cross-sectional view, along a line VII to VII, of purge mechanism 56 when a nozzle cap 152 and an exhaust pipe 153 are disposed at their standby positions.

FIG. 8 is a cross-sectional view, along the line VII to VII, of purge mechanism 56 when nozzle cap 152 and exhaust pipe 153 are disposed at their tightly-contact positions.

FIG. 9 is a bottom view of a recording head 39.

FIG. 10 is an enlarged, cross-sectional view of an internal configuration of recording head 39.

FIG. 11 is a block diagram showing the configuration of a control section 71 of multi-function device 1.

FIG. 12 is an enlarged, plan view of an external configuration of a carriage 38.

FIG. 13 is a right side view of carriage 38.

FIG. 14 is a cross-sectional view, along a line XIV-XIV, of carriage 38.

FIG. 15 is an exploded, perspective view of the configurations of a slide member 91, a coil spring 92, and a gap adjustment member 93.

FIG. 16 is another right side view of carriage 38.

FIG. 17 is another cross-sectional view, along the line XIV-XIV, of carriage 38.

FIG. 18 is still another right side view of carriage 38.

FIG. 19 is still another cross-sectional view, along the line XIV-XIV, of carriage 38.

FIG. 20 is a plan view of a timing belt 49 placed across a drive pulley 47 and follower pulley 48.

FIG. 21 is a cross-sectional view of drive pulley 47 meshing with timing belt 49.

FIG. 22 is a cross-sectional view of follower pulley 48, showing follower pulley 48 wound with a toothed section 116 of timing belt 49.

FIG. 23 is an enlarged, plan view of a position P1 in FIG. 20.

FIG. 24 is an enlarged, plan view of a position P2 in FIG. 20.

FIG. 25 is a cross-sectional view of follower pulley 48, showing follower pulley 48 wound with a toothless section 117 of timing belt 49.

FIG. 26 is a side view showing the relationship between the positions of carriage 38 and timing belt 49.

FIG. 27 is a partial, bottom view of a carriage 130, showing the lower surface of carriage 130 in a modified example of the gap switching mechanism.

FIG. 28 is a perspective view of the external configurations of a rotation axis 132 and a slider 133.

FIG. 29 is a perspective view of the external configuration of rotation axis 132.

FIG. 30 is a side view of rotation axis 132 and of slider 133.

FIG. 31 is a schematic diagram showing a first position of a known carriage 202, as carriage 202 moves back and forth on a guide rail 201.

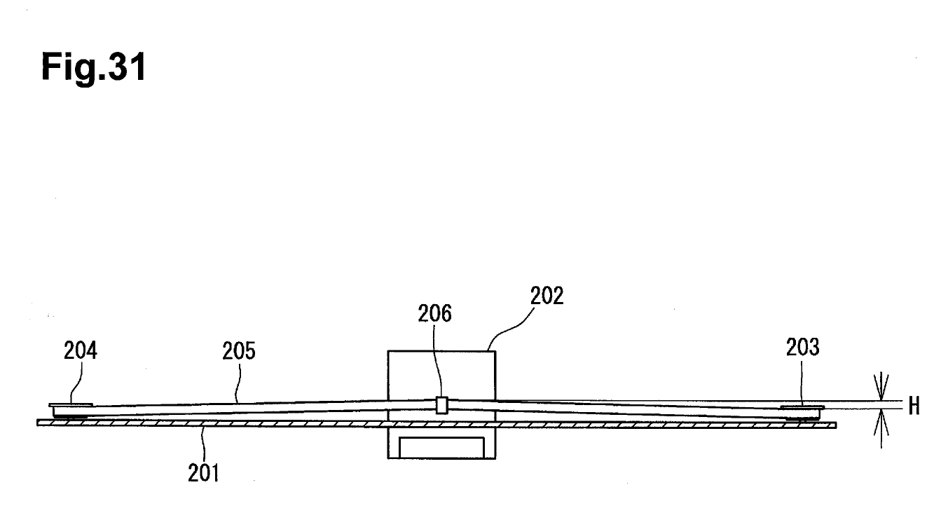

FIG. 32 is another schematic diagram showing a second position of known carriage 202, as carriage 202 moves back and forth on the guide rail 201.

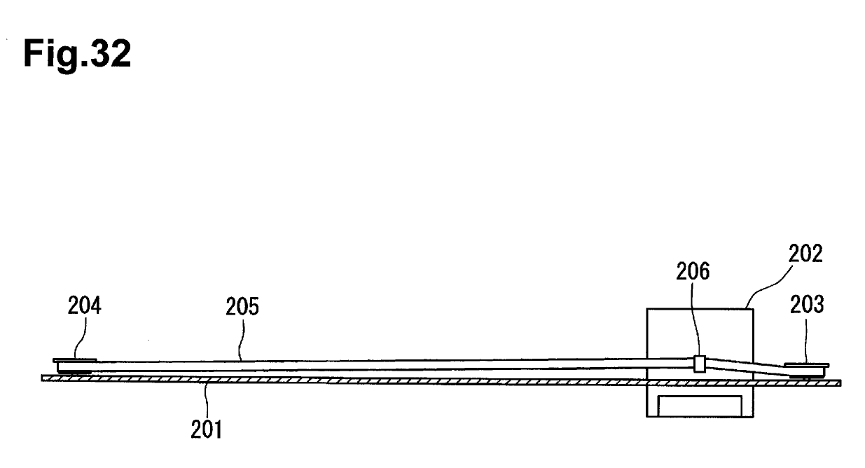

### DESCRIPTION OF PREFERRED EMBODIMENTS

An embodiment of the invention now is described by referring to the accompanying drawings as appropriate. The embodiment is in all aspects illustrative and not restrictive, and it is understood that modifications and variations may be devised without departing from the scope of the invention.

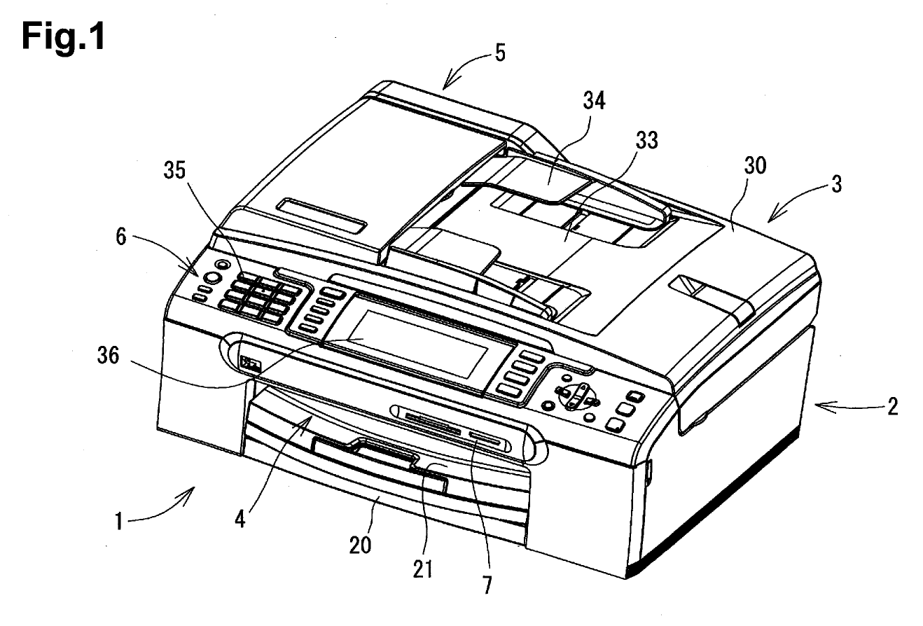

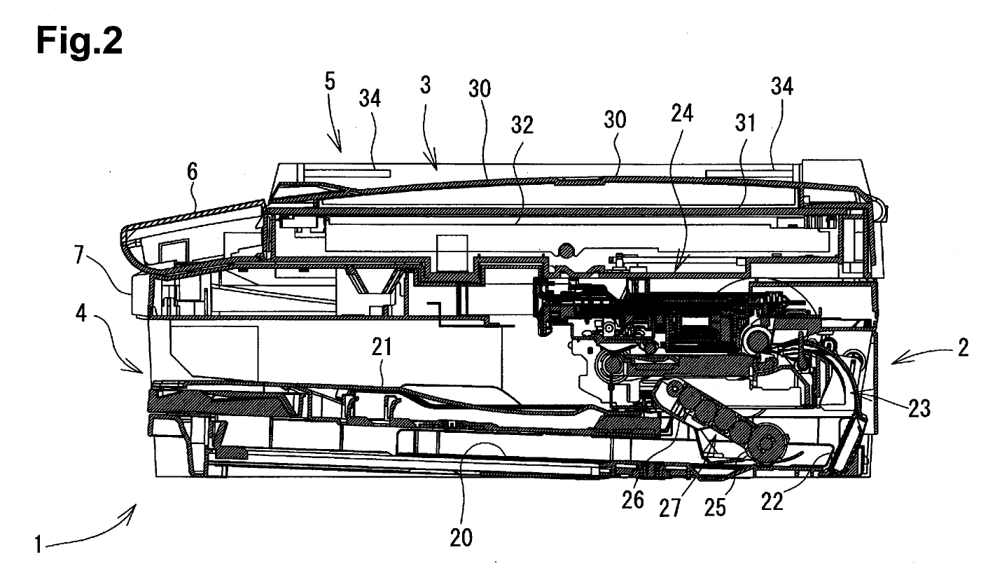

FIG. 1 shows an external configuration of a multi-function device 1, e.g., image formation device, according to embodiment of the invention. FIG. 2 is a vertical, cross-sectional view showing an internal configuration of multi-function device 1. Multi-function device 1 comprises a printer section 2 at a lower portion and a scanner section 3 at an upper portion. Multi-function device 1 may be configured for printing, scanning, copying, and faxing. In multi-function device 1, printer section 2 may correspond to the image formation device according to the invention, but other capabilities, except printing, are arbitrary. The invention thus may be implemented as a single-function printer, which is not capable of scanning and copying without scanner section 3.

For printing, multi-function device 1 may be connected to a computer (not shown), and printer section 2 records images and documents to a recording medium, e.g., recording paper, based on image data and document data received from the computer. Printer section 2 also records to the recording medium image data received from any external equipment, e.g., a digital camera, connected to multi-function device 1. Printer section 2 also records to the recording medium image data or other data stored on various types of storage media, e.g., a memory card, attached to multi-function device 1.

For scanning, the image data of reading media, e.g., a document, which is read by scanner section 3, may be forwarded to the computer. The image data also may be stored on various types of storage media, such as a memory card. For copying, the image data, which is read by scanner section 3, is recorded to the recording medium in printer section 2. For faxing, the image data, which is read by scanner section 3 is faxed over a telephone line. Thus, received fax data is recorded to the recording paper by printer section 2.

As shown in FIG. 1, multi-function device 1 may be shaped substantially like a rectangular parallelepiped, e.g., the breadth and depth are larger than the height. Multi-function device 1 comprises printer section 2 at its lower portion. Printer section 2 is formed with an aperture 4 on the front surface. Inside of aperture 4, a paper-feed tray 20 and a paper-ejection tray 21 are disposed with one above the other. Paper-feed tray 20 carries therein recording media, e.g., recording papers, and may house therein various sizes of recording media smaller than A4 size papers, e.g., B5 size or postcard size. Although not shown in FIG. 1, the tray surface of paper-feed tray 20 increases in size when slid toward the front side of the device. Thus, size-increased, paper-feed tray 20 may house thereon recording media of legal size. Recording media housed in paper-feed tray 20 is directed to inside of printer section 2 for recording of any desired image, and then is ejected onto paper-ejection tray 21.

Multi-function device 1 includes scanner section 3 at its upper portion. Scanner section 3 is configured as a so-called flatbed scanner. As shown in FIGS. 1 and 2, a platen glass 31 and an image sensor 32 are disposed below a manuscript cover 30, which is provided to be able to freely open and close as a top plate of multi-function device 1. On the platen glass 31, a manuscript is placed for image reading, and below the platen glass 31, image sensor 32 is configured to move back and forth in the width direction of multi-function device 1, i.e., the vertical direction in FIG. 2. Image sensor 32 primarily scans in the depth direction of multi-function device 1.

Manuscript cover 30 is provided with an automatic document feeder (“ADF”) 5 to sequentially transfer a document to a paper-ejection tray 34 from a document tray 33 via a document transfer path (not shown). During such document transfer by ADF 5, a document is transferred onto platen glass 31, and image sensor 32 being on standby below platen glass 31 reads images of the document. In this embodiment of the invention, scanner section 3 and ADF 5 are both arbitrary and have no necessary relationship to the claimed invention, and, thus, are not described here in detail.

Multi-function device 1 comprises an operation panel 6 at the upper, front portion for use to operate printer section 2 and scanner section 3. Operation panel 6 comprises various types of operation buttons 35, and a liquid crystal display 36. Multi-function device 1 operates in response to operation commands received from operation panel 6. When connected to any external computer, multi-function device 1 also operates in response to commands received from the computer via a printer driver or a scanner driver.

Multi-function device 1 comprised a slot section 7 formed on the front surface. Slot section 7 receives various types of storage media, e.g., reduced sized memory cards. When operation panel 6 operates in a predetermined manner, image data stored on a memory card loaded into slot section 7 is read out. Information about read image data is displayed on liquid crystal display 36, for example, and an image arbitrarily selected based on the operation of operation buttons 35 is recorded to a recording media by printer section 2.

By referring to the accompanying drawings as appropriate, the internal configuration of multi-function device 1, and especially, the configuration of printer section 2, now is described. As shown in FIG. 2, on the depth side of paper-feed tray 20 disposed at the bottom side of multi-function device 1, a sloped separation plate 22 slopes toward the rear surface side of the device. Sloped separation plate 22 separates and guides upward a recording media received from paper-feed tray 20. A paper transfer path 23 extends above sloped separation plate 22. Paper transfer path 23 leads to paper-ejection tray 21 by extending upward from sloped separation plate 22, bending towards the front surface side, extending from the rear surface side of multi-function device 1 to the front surface side thereof, and then passing over an image recording unit 24. The recording media housed on paper-feed tray 20 is guided along paper transfer path 23 making a corresponding U-turn from the lower to upper portions, and reaches the image recording unit 24. After being subjected to image recording by image recording unit 24, the recording media is ejected onto paper-ejection tray 21.

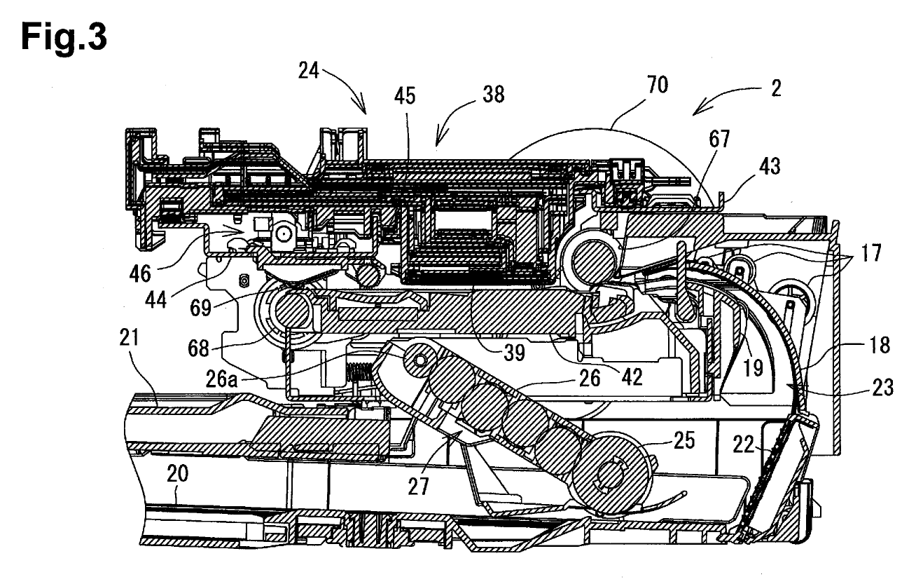

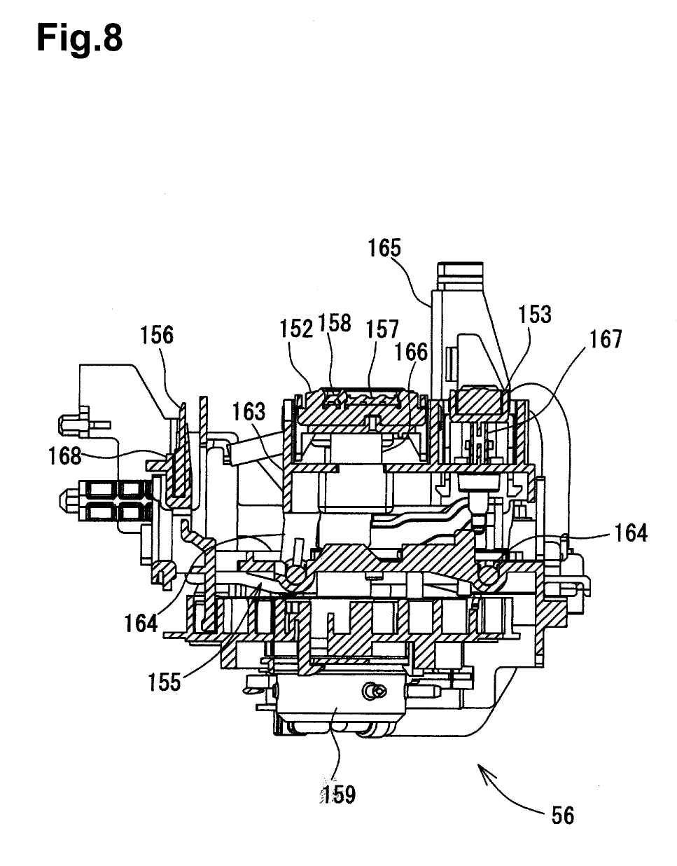

FIG. 3 is a partially-enlarged, cross-sectional view of the configuration of printer section 2. As shown in FIG. 3, a paper-feed roller 25 is disposed above the paper-feed tray 20. Paper-feed roller 25 is pressed tightly against the stack of recording media piled on paper-feed tray 20, and forwards the media to sloped separation plate 22. Paper-feed roller 25 pivots at the tip end of a paper-feed arm 26. Referring to FIG. 8, paper-feed roller 25 may be rotated by a driving force transmission mechanism 27 in response to a driving force generated by an LF motor 78. Driving force transmission mechanism 27 comprises a plurality of gears meshed with one another.

Paper feed arm 26 moves in the vertical direction about a base axis 26a to approach or to move away from paper-feed tray 20. As shown in FIG. 3, paper-feed arm 26 pivots downward to come into contact with paper-feed tray 20 as a result of its own weight, and paper-feed roller 25 thereby comes into contact with paper-feed tray 20. When paper-feed tray 20 and paper-ejection tray 21 are removed from aperture 4, paper-feed arm 26 moves upward out of the removal path. When paper-feed roller 25 rotates while tightly pressed against the surface of the stack of the recording media on paper-feed tray 20, the recording medium located at the top of the stack transfers to sloped separation plate 22 by the friction force between the roller surface of paper-feed roller 25 and the recording medium. The recording medium abuts the tip end of sloped separation plate 22 and is guided upward, e.g., to paper transfer path 23. When the recording medium at the top is withdrawn by paper-feed roller 25, the recording media immediately there beneath also may be withdrawn due to friction or static electricity. If this is the case, however, the recording medium is stopped by abutting sloped separation plate 22.

Except for the portion in which image recording unit 24 is disposed, paper transfer path 23 is configured by an outer guide surface and an inner guide surface, which are opposing each other with a predetermined space there between. For example, paper transfer path 23 on the rear surface side of multi-function device 1 comprises an outer guide member 18 and an inner guide member 19 fixed inside of the frame. Outer guide member 18 comprises transfer rollers 17, whose roller surfaces are each exposed from the guide surface of outer guide member 18. The exposed portions of transfer rollers 17 are supported by outer guide member 18 to freely rotate in the width direction of paper transfer path 23, e.g., the axial direction. Such transfer rollers 17 smoothly transfer of a recording medium coming into contact with the outer guide surface at a position at which paper transfer path 23 curves like a letter U.

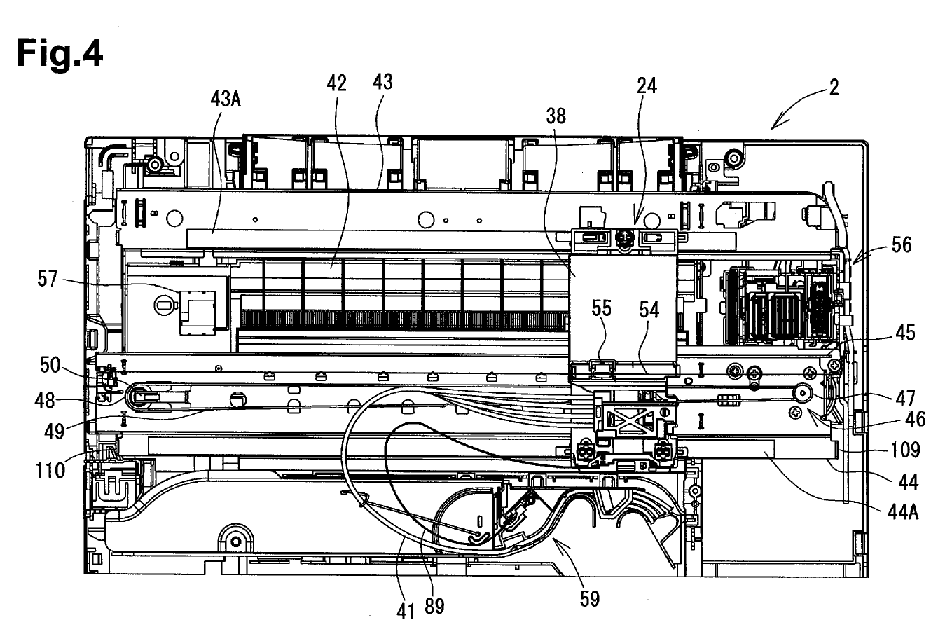

As shown in FIG. 3, paper transfer path 23 is provided with image recording unit 24. Image recording unit 24 comprises a carriage 38 that moves back and forth in the main scanning direction with a recording head 39 disposed thereon. The detailed configuration of carriage 38 is described below. Referring to FIG. 4, recording head 39 receives various colors of inks, e.g., cyan (C), magenta (M), yellow (Y), and black (Bk), from ink cartridges through ink tubes 41. The ink cartridges are disposed away from recording head 39 inside of multi-function device 1. Recording head 39 selectively discharges the inks as minute ink droplets. As such, by recording head 39 selectively discharging the ink droplets while carriage 38 moves back and forth, the recording media passing over a platen 42 is recorded with an image(s).

FIG. 4 is a plan view of the configuration of printer section 2. As shown in FIG. 4, a pair of guide rails 43 and 44 extends in the direction orthogonal to the direction of transfer of the recording media, i.e., the lateral direction in FIG. 4. Guide rails 43 and 44 are disposed above paper transfer path 23 with a predetermined space in the direction of transfer of the recording media, i.e., the vertical direction in FIG. 4. Carriage 38 is disposed, to move back and forth across and over the guide rails 43 and 44 in the horizontal direction orthogonal to the direction of transfer of the recording media. Guide rail 43 disposed upstream of the paper-transfer direction is a flat, elongated plate, e.g., the dimension in the width direction of paper transfer path 23 is greater than the range in which carriage 38 moves back and forth. The upper surface of guide rail 43 on the downstream side of the paper-transfer direction is a guide surface 43A, which slidably supports the upstream, end portion of carriage 38.

Guide rail 44 disposed downstream of the paper-transfer direction is a flat, elongated plate whose dimension in width direction of paper transfer path 23 is about equal to that of guide rail 43. In guide rail 44, an upstream, end portion 45 bends upward at substantially 90 degrees. The upper surface of guide rail 44 on the downstream side of the paper-transfer direction is a guide surface 44A, which slidably supports the downstream, end portion of carriage 38. Carriage 38 pinches edge portion 45 using a roller (not shown) or the like. With such pinching, carriage 38 is supported on guide surfaces 43A and 44A of guide rails 43 and 44 to slide freely, so that carriage 38 moves back and forth in the horizontal direction orthogonal to the paper-transfer direction relative to end portion 45 of guide rail 44.

Guide rail 44 comprises a belt drive mechanism 46 along and on the upper surface of guide rail 44. In belt drive mechanism 46, a timing belt 49 extends across the drive and follower pulleys 47 and 48. Drive and follower pulleys 47 and 48 are disposed in the vicinity of and at opposite ends in the width direction of paper transfer path 23. Timing belt 49 may be an endless-loop with teeth inside. The coupling between timing belt 49 and carriage 38 allows carriage 38 to move back and forth in response to the operation of belt drive mechanism 46.

Drive pulley 47 is disposed on one end, e.g., the right-side end in FIG. 4, of the upper surface of guide rail 44 to rotate freely in the axial direction, orthogonal to guide surface 44A of guide rail 44. In particular, the axis of drive pulley 47 is oriented in the vertical direction. Although not shown in FIG. 4, a CR motor 80 (the drive source, refer to FIG. 8) is disposed below guide rail 44, and CR motor 80 supplies a driving force to the axis of drive pulley 47. In response to this driving force, drive pulley 47 rotates.

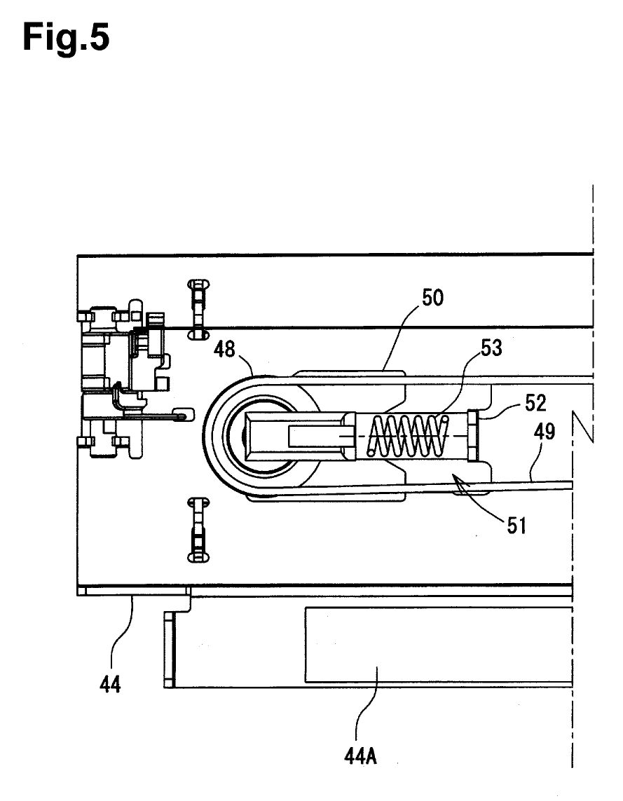

FIG. 5 is an enlarged, plan view of configuration of follower pulley 48 and the surrounding components. Follower pulley 48 is supported by a pulley holder 50 to rotate freely. Guide rail 44 comprises an attachment hole 51 formed at the position at which pulley holder 50 is attached. Such attachment hole 51 receives pulley holder 50, and the circumferential edge of attachment hole 51 snap fits to pulley holder 50. Through such snap fitting, pulley holder 50 is attached to guide rail 44 to slide in the longitudinal direction of timing belt 49. In this configuration, follower pulley 48 freely rotates in the axial direction, orthogonal to guide surface 44A of guide rail 44. In particular, the axis of follower pulley 48 is directed in the longitudinal direction. Follower pulley 48 is disposed in the direction along which guide rail 44 extends from proximate to drive pulley 47 e.g., substantially along the width of guide rail 44.

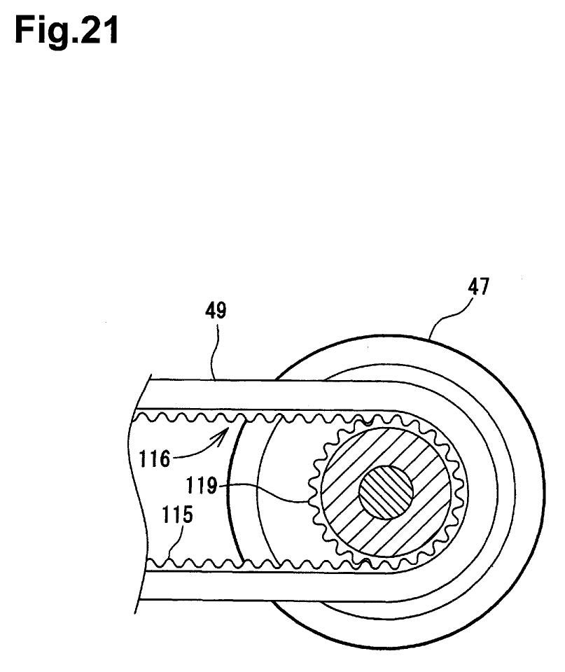

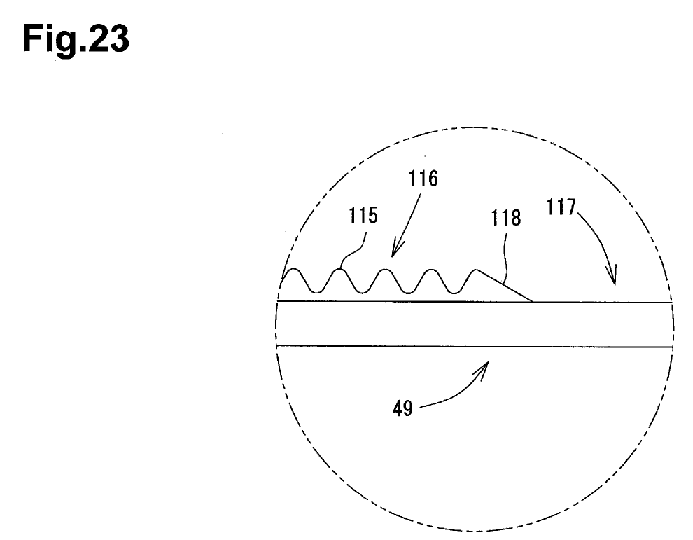

As shown in FIG. 4, drive and follower pulleys 47 and 48 are wound with timing belt 49. Although not shown in FIGS. 4 and 5, timing belt 49 comprises an inner tooth 115, such as a spur tooth (refer to FIG. 23), protruding inside of the circular or oval shape. The outer rim of drive pulley 47 comprises a spur tooth 119 for meshing with inner tooth 115 of timing belt 49 (refer to FIG. 21). Thus, the rotation force of drive pulley 47 transfers reliability to timing belt 49, so that timing belt 49 moves circumferentially. As shown in FIG. 5, a coil spring 53 is compressed between pulley holder 50 and a spring support piece 52. Spring support piece 52 is a cut-out portion of the circumferential edge of attachment hole 51. Coil spring 53 biases pulley holder 50 toward the outside of guide rail 44, e.g., the left side in FIG. 5. Such biasing stops pulley holder 50 from sliding at the position at which the tension of timing belt 49 is balanced with the elastic biasing force of coil spring 53, so that an appropriate tension is applied to timing belt 49. Although timing belt 49 is an endless loop in this embodiment, this configuration is not required, and a timing belt may have ends. In such a configuration, the ends of the timing belt may be coupled to carriage 38.

Carriage 38 is coupled to timing belt 49. When timing belt 49 moves circumferentially, carriage 38 starts moving back and forth on guide rails 43 and 44 relative to edge portion 45. With recording head 39 mounted on carriage 38, recording head 39 moves back and forth in the width direction of paper transfer path 23, e.g., the main scanning direction.

Referring to FIG. 8, an encoder strip 54 of a linear encoder 84 (refer to FIG. 8) is disposed along edge portion 45 of guide rail 44. Linear encoder 84 detects encoder strip 54 using a photo interrupter 55 mounted on carriage 38. A detection signal coming from linear encoder 84 is used as a basis for exercising control over the back-and-forth movement of carriage 38.

As shown in FIG. 4, platen 42 is disposed below paper transfer path 23 so as to oppose recording head 39. In the range in which carriage 38 moves back and forth, platen 42 is disposed across the center portion over which the recording media passes. The width of platen 42 is much greater than the maximum width of the recording media available for transfer, and the ends of the recording media pass over platen 42. Platen 42 and the pair of guide rails 43 and 44 are parallel with a predetermined space defined there between, and the lower surface of recording head 39 is opposed to the upper surface of platen 42 with a predetermined head gap. Recording head 39 is mounted on carriage 38 which slides on guide rails 43 and 44.

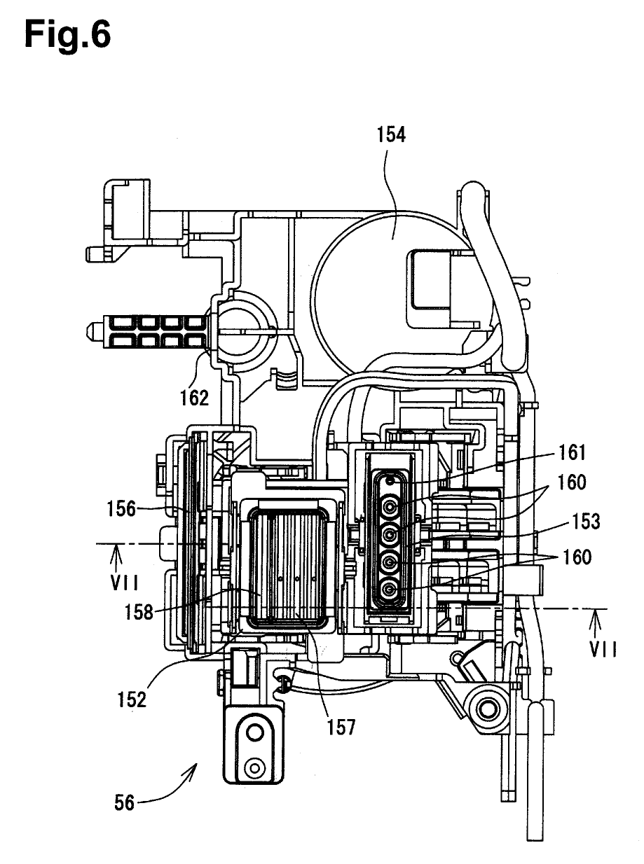

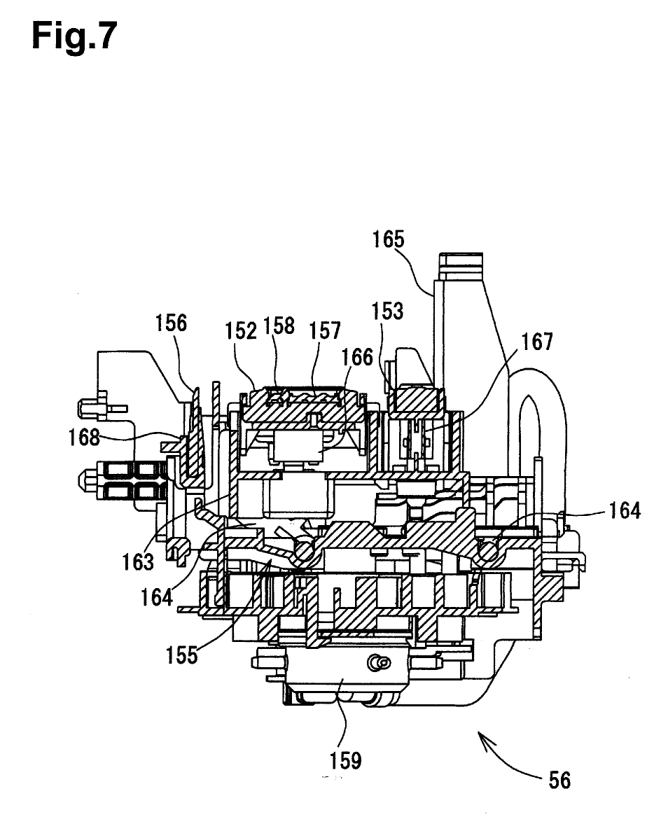

In the area in which no recording media passes, e.g., the outside of the image recording area used by recording head 39, maintenance units may be disposed, e.g., purge mechanism 56 and a waste ink tray 57. FIG. 6 is a plan view showing the configuration of purge mechanism 56. FIG. 7 is a cross-sectional view, along a line VII to VII, of purge mechanism 56 of FIG. 6, and FIG. 8 is a cross-sectional diagram showing the configuration in which a nozzle cap 152 and an exhaust cap 153 are raised.

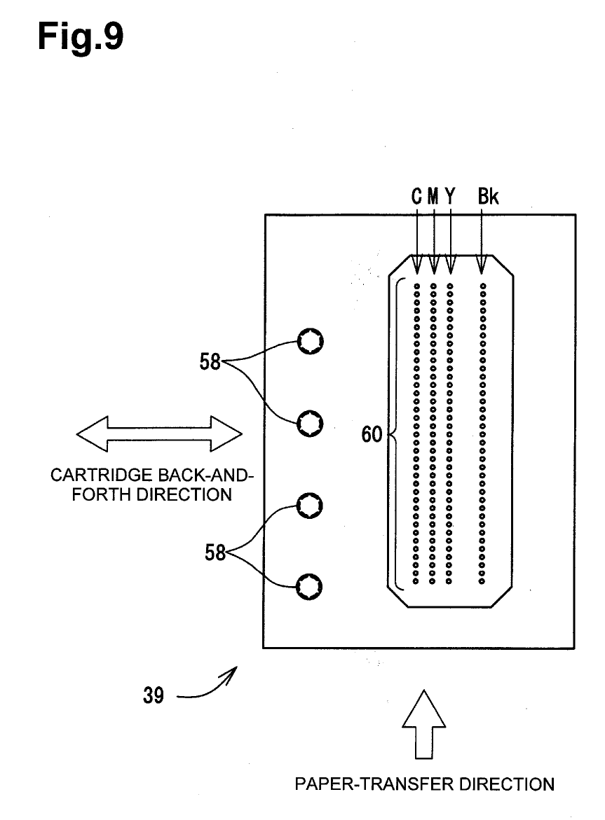

Purge mechanism 56 withdraws and removes bubbles and foreign substances from the nozzle of recording head 39. As shown in FIGS. 6 to 8, purge mechanism 56 is comprises nozzle cap 152, exhaust cap 153, a pump 154, a lift-up mechanism 155, and a wiper blade 156. Referring to FIG. 9, nozzle cap 152 covers a nozzle 60 of recording head 39 (refer to FIG. 9), and the exhaust cap 153 is connected to exhaust ports 58 of recording head 39. Pump 154 is connected to nozzle cap 152 or exhaust cap 153 for withdrawing bubbles and foreign substances. Lift-up mechanism 155 moves nozzle cap 152 and exhaust cap 153 close to or away from recording head 39. Wiper blade 156 wipes nozzle surface of recording head 39.

Nozzle cap 152 may be a rubber-made cap that seals around nozzle 60 of recording head 39. Nozzle cap 152 may be partitioned inside into two spaces for color inks of CMY ink and a black ink (Bk). Support members 157 and 158 are inserted respectively into the two spaces, so that the rip portion of nozzle cap 152 is prevented from falling. Although not shown, the two spaces of nozzle cap 152 each are formed with a withdrawing port for connection to the pump 154 at the bottom portion via a port switching mechanism 159, which governs port switching using a cam.

Referring to FIG. 9, exhaust cap 153 may be a rubber-made cap that seals around exhaust ports 58 of recording head 39. Inside of exhaust cap 153, four pushrods 160 vertically. Pushrods 160 are those corresponding to exhaust ports 58 of the inks of CMYBk. Check valves of exhaust ports 58 are relieved when pushrods 160 are inserted into exhaust ports 58. Pushrods 160 protrude upward from exhaust caps 153. For example, three pushrods 160 corresponding to the color inks of CMY are configured to protrude separately from the remaining pushrod 160 which corresponds to the black ink (Bk). Either or both sets of pushrods 160 protrude, so that pushrods (s) 160 are received into exhaust port(s) 58 corresponding to the color inks or the black ink of recording head 39. Exhaust cap 153 comprises a withdrawing port 161 at the bottom portion for connection to pump 154 via port switching mechanism 159.

Port switching mechanism 159 selectively switches the connection state of suction paths, i.e., whether to establish a connection to pump 154 or cut off the connection thereto. The suction paths comprise a path connected to the suction port of nozzle cap 152, and a path connected to suction port 161 of exhaust cap 153.

Pump 154 may be a so-called rotary pump, and when the pump gear is rotated, suction occurs. The pump gear receives a driving force through a bevel gear 162. Although the details about the pump gear and the driving force transfer mechanism therefor are not shown, the pump gear is rotated in response to the rotation force applied to bevel gear 162, and pump 154 starts executing a suction operation.

Lift-up mechanism 155 is configured to move a holder 163 parallel to and between its standby position and tight-contact position by means of a pair of right and left, equal-length links 164. FIG. 7 shows holder 163 located at its standby position, and FIG. 8 shows holder 163 located at its tight-contact position. Equal-length links 164 move holder 163 in the lateral direction of FIGS. 7 and 8, i.e., the direction along which carriage 38 moves back and forth. Although not shown, holder 163 is urged to the standby position by a spring biasing force. Holder 163 is provided with an abutting lever 165 protruding vertically. When carriage 38 pushes abutting lever 165 toward the rightward direction in FIG. 7, holder 163 moves to the tight-contact position, as shown in FIG. 8, against the spring biasing force. Holder 163 carries thereon nozzle cap 152 and exhaust cap 153, which are biased upward by coil springs 166 and 167, respectively. As a result of holder 163 moving to the tight-contact position, nozzle cap 152 and exhaust cap 153 are sealed around nozzle 60 and exhaust ports 58 of recording head 39. At the tight-contact position, coil springs 166 and 167 are compressed, and nozzle cap 152 and exhaust cap 153 are biased elastically by coil springs 166 and 167, so that nozzle 60 and exhaust ports 58 of recording head 39 remain sealed tightly.

Wiper blade 156 is mounted on a wiper holder 168 and protrudes therefrom. Wiper blade 156 may be a rubber-made blade, having the length corresponding to the length of the lower surface of recording head 39 in the paper-transfer direction. When protruding from wiper holder 168, wiper blade 156 abuts the lower surface of recording head 39. When recording head 39 slides together with carriage 38 while wiper blade 156 abuts the lower surface of recording head 39, wiper blade 156 wipes the ink attached to the lower surface. Wiper blade 156 is controlled by a cam mechanism (not shown) whether or not to protrude, i.e., wiper blade 156 protrudes when recording head 39 slides to the image recording area side after purging.

For withdrawing and removing bubbles or other foreign substances from recording head 39, carriage 38 moves, so that recording head 39 comes on nozzle cap 152 and exhaust cap 153. When abutting lever 165 pushes toward carriage 38, lift-up mechanism 155 moves both nozzle cap 152 and exhaust cap 153 to their tight-contact positions to make those closely seal nozzle 60 and exhaust ports 58 of recording head 39. Port switching mechanism 159 switches the connection state of nozzle cap 152 and exhaust cap 153 with pump 154, i.e., whether to establish a predetermined connection or cut off the connection. When nozzle 60 of recording head 39 withdraws an ink, nozzle cap 152 is put into the connection state, and exhaust cap 153 is put into the connection cut-off state. In this configuration, when pump 154 receives a driving force of LF motor 78, pump 154 executes the suction operation. During the suction operation of pump 154, the pressure inside of nozzle cap 152 is changed to negative, and nozzle 60 of recording head 39 starts withdrawing the ink. Bubbles and foreign substances in nozzle 60 are withdrawn and removed together with the ink. Thereafter, when carriage 38 slides away from abutting lever 165, lift-up mechanism 155 moves nozzle cap 152 and exhaust cap 153 to their standby positions. When wiper blade 156 abuts lower surface of recording head 39 mounted on sliding carriage 38, wiper blade 156 wipes out the ink, if any, attached to the lower surface.

Purge mechanism 56 also functions as a capping mechanism without going through the purge operation. For capping, similar to the description above, carriage 38 moves, so that recording head 39 comes on to nozzle cap 152 and exhaust cap 153. When abutting lever 165 pushes toward carriage 38, lift-up mechanism 155 moves both nozzle cap 152 and exhaust cap 153 to their tight-contact positions to make those closely seal nozzle 60 and exhaust ports 58 of recording head 39. Thus, the ink is retained in nozzle cap 152, even with any ink leakage from nozzle 60 of the recording head 39 at the time of storage or transfer of multi-function device 1. Such a purge mechanism corresponds to the load mechanism of the invention.

Waste ink tray 57 is provided to receive any empty discharge of ink from recording head 39. Such empty discharge of ink is called flashing. As shown in FIG. 4, waste ink tray 57 is disposed, as a piece with platen 42, within a range in which carriage 38 moves back and forth, but not in an image recording area. Such a maintenance unit performs maintenance of removing bubbles inside of recording head 39 or any blended ink, for example.

Recording head 39 receives inks through ink tubes 41 coupled to the ink cartridges that are not shown. An ink cartridge may be provided for each of various colors of inks, and the inks are supplied to recording head 39 via ink tubes 41, which are provided to each of the cartridges. Each of ink tubes 41 may be a synthetic-resin-made tube, and are all made flexible to change in shape in accordance with the back-and-forth movement of each of carriage 38.

As shown in FIG. 4, each of ink tubes 41 is coupled to a corresponding ink cartridge, and ink tubes 41 are pulled along the width direction of the device up to the center and therearound for fixation to a fixing clip 59 on the device frame. In FIG. 4, ink tubes 41 extending from fixing clip 59 toward the side of the ink cartridges are not shown. On the way from fixing clip 59 to carriage 38, ink tubes 41 are not fixed to the device frame, and change in shape in accordance with the back and fourth movement of carriage 38. In particular, when carriage 38 moves toward an end of its back and forth movement, e.g., the left side in FIG. 4, ink tubes 41 start moving in the same direction as carriage 38 while changing in shape so, that the radius of the U-shaped bent portion is reduced. On the other hand, when carriage 38 moves toward the other end of its back and forth movement, e.g., the right side in FIG. 4, ink tubes 41 start moving in the same direction as carriage 38 while deforming, so that the radius of the U-shaped bent portion increases.

FIG. 9 is a bottom view of recording head 39 showing the nozzle surface thereof. As shown in FIG. 9, recording head 39 comprises nozzle 60 with an open surface on its lower surface. In nozzle 60, nozzle openings are aligned in the paper-transfer direction, and are provided in line for each of the inks varying in color, i.e., cyan (C), magenta (M), yellow (Y), and black (Bk). In FIG. 9, the vertical direction is the paper-transfer direction, and the lateral direction is the direction along which carriage 38 moves back and forth. The nozzle openings of nozzle 60 for various colors of inks, i.e., CMYBk, are aligned in the direction along which carriage 38 moves back and forth. With respect to nozzles 60, the pitch and the number in the paper-transfer direction are set as appropriate in consideration of the resolution of recording images or others. The number of lines of the nozzle openings of nozzle 60 may be increased or decreased depending on the number of types of the color inks.

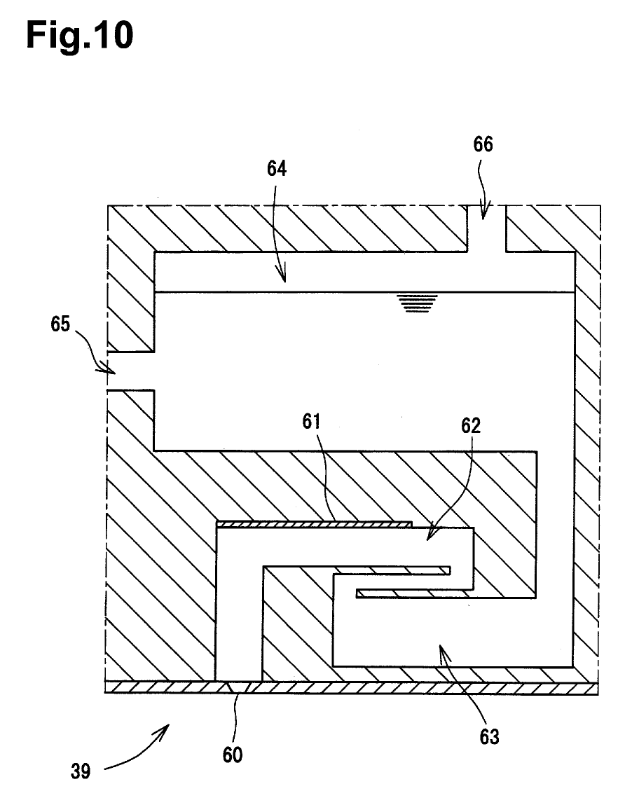

Exhaust ports 58 are formed on the side of nozzle 60. The exhaust ports 58 also are provided for each of the four inks varying in color, i.e., CMYBk. Although not shown, exhaust ports 58 each serve as a path for a check valve, and are relieved when pushrods 160 of purge mechanism 56 are inserted thereinto. A path is formed inside of inkjet recording head 39 from exhaust ports 58 to a bubble exhaust port 66. Bubble exhaust port 66 is described below with reference to FIG. 10. As a result of pump 154 creating negative pressure inside of exhaust cap 153 when exhaust ports 58 are relieved, air stored in a buffer tank 64, as shown in FIG. 10, is withdrawn.

FIG. 10 is a partially-enlarged, cross-sectional view of recording head 39, showing the internal configuration thereof. As shown in FIG. 10, a cavity 62 is formed upstream of nozzle 60 formed to the lower surface of recording head 39. Cavity 62 contains a piezoelectric element 61. Piezoelectric element 61 changes shape when voltage of a predetermined level is applied thereto, so that cavity 62 is reduced in capacity. As a result of the capacity reduction of cavity 62, the ink inside of cavity 62 is discharged from nozzle 60 as ink droplets.

Cavity 62 is formed to each of nozzles 60, and a manifold 63 is formed across a plurality of cavities 62. Manifold 63 is provided for each of the inks varying in colors, i.e., CMYBk. Buffer tank 64 is disposed upstream of manifold 63, and also is provided for each of the inks varying in colors, i.e., CMYBk. From an ink supply port 65, buffer tanks 64 are respectively provided with an ink from ink cartridges 40 through ink tubes 41. Because buffer tanks 64 temporarily store the ink, ink bubbles produced in the ink by ink tubes 41 are captured, so that cavities 62 and manifolds 63 are protected from incoming ink bubbles. The ink bubbles captured inside of buffer tanks 64 are withdrawn via bubble exhaust port 66 by purge mechanism 56 via exhaust ports 58, as shown in FIG. 9. The ink supplied from buffer tanks 64 to manifolds 63 is distributed by manifolds 63 to cavities 62.

Consequently, for each of the color inks provided by ink cartridges 40 via ink tubes 41, an ink path is establishment for ink flow to the corresponding cavity 62 via the corresponding buffer tank 64 and manifold 63. The inks varying in color, e.g., CMYBk, received through the ink paths are discharged selectively onto a recording paper in the shape of ink droplets from nozzle 60 by piezoelectric elements 61 selectively changing in shape.

As shown in FIG. 3, a transfer roller 67 is disposed upstream of image recording unit 24. Although not shown in FIG. 3, a pinch roller is disposed at a position opposing transfer roller 67. The pinch roller is biased to pressed tightly against transfer roller 67. When a recording medium comes between transfer roller 67 and the pinch roller, the pinch roller recedes by medium the thickness of the recording medium to pinch the recording medium with transfer roller 67. This configuration facilitates the reliable transfer the rotation force of transfer roller 67 to the recording medium. The recording medium then is transferred onto platen 42. A paper-ejection roller 68 is provided downstream of image recording unit 24. A spur roller 69 is disposed at a position opposing paper-ejection roller 68. Spur roller 69 is tightly pressed against paper-ejection roller 68, and the image-recorded, recording medium is pinched and transferred by paper-ejection roller 68 and spur roller 69. The roller surface of spur roller 69 is uneven, e.g., spur-like, to prevent the degradation of images recorded on the recording media. Although spur roller 69 is biased to press tightly against paper-ejection roller 68 similar to the pinch roller, spur roller 69 is pressed tightly against the image-recorded, recording medium.

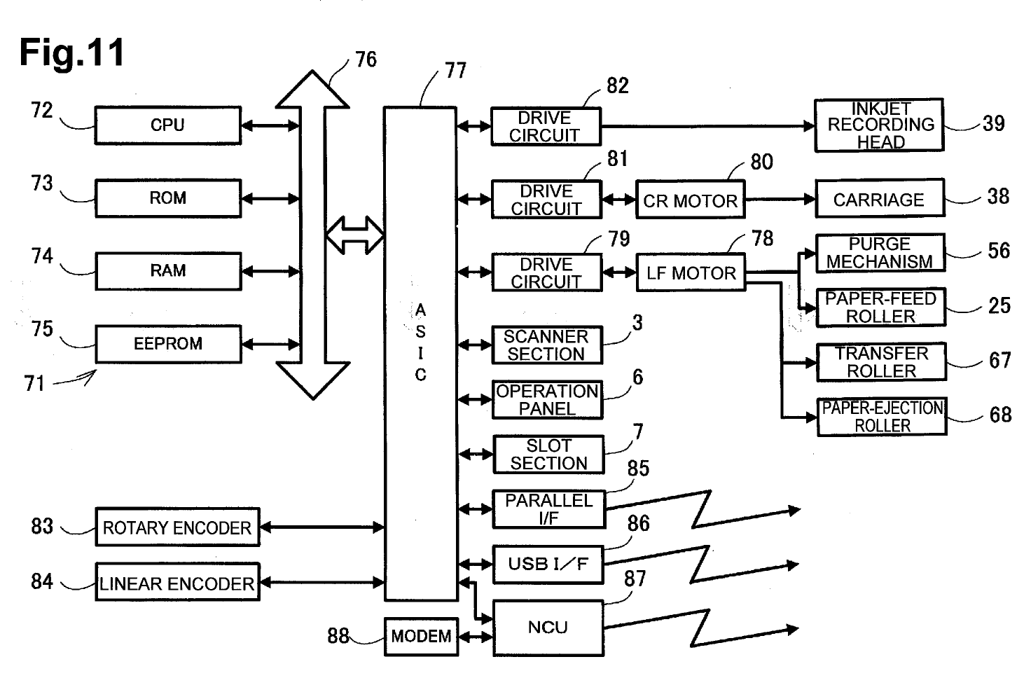

In response to a driving force coming from LF motor 78, as shown in FIG. 11, transfer roller 67 and paper-ejection roller 68 are driven intermittently with a predetermined line feed pitch. Transfer roller 67 and paper-ejection roller 68 synchronously rotate, and an encoder disk 70 exercises control over the rotation of transfer roller 67 and of paper-ejection roller 68. Encoder disk 70 is detected by means of a photo interrupter of a rotary encoder 83, as shown in FIG. 11, provided to transfer roller 67. Encoder disk 70 rotates together with transfer roller 67.

FIG. 11 is a block diagram showing the configuration of a control section 71 of multi-function device 1. Control section 71 exercises control entirely over the operation of multi-function device 1, including not only printer section 3, but also scanner section 2. As shown in the drawing, control section 71 comprises a microcomputer, comprising a (“ROM”) Central Processing Unit (“CPU”) 72, a Read Only Memory (“ROM”) 73, a Random Access Memory (“RAM”) 74, and an Electrically Erasable and Programmable ROM (“EEPROM”) 75. Control section 71 is connected to an Application Specific Integrated Circuit (“ASIC”) 77 over a bus 76.

ROM 73 stores therein a program or the like for controlling the various operations of multi-function device 1. RAM 74 is used as a storage area or a working area for temporarily storing various types of data for use when CPU 72 runs the program. EEPROM 75 stores therein setting details or flags that are retained even after the power is turned off.

By following a command coming from CPU 72, ASIC 77 generates a phase excitation signal or others signals to energize LF motor 78. ASIC 77 then forwards the generated signal to a drive circuit 79 of LF motor 78, and provides a drive signal to energize LF motor 78 via drive circuit 79, thereby exercising control over the rotation of LF motor 78.

Drive circuit 79 drives LF motor 78 connected to the components, e.g., paper-feed roller 25, transfer roller 67, paper-ejection roller 68, and purge mechanism 56. In response to an output signal coming from ASIC 77, drive circuit 79 forms an electric signal for rotating LF motor 78. After receiving the electric signal, LF motor 78 starts rotating, and the rotation force of LF motor 78 is transmitted selectively to the components, e.g., paper-feed roller 25, transfer roller 67, paper-ejection roller 68, and purge mechanism 56. Such transmission may be made via any known drive mechanism including a gear, a drive shaft, or the like.

In response to a command coming from CPU 72, ASIC 77 generates a phase excitation signal or the like to energize CR motor 80. ASIC 77 then forwards the generated signal to a drive circuit 81 of CR motor 80, and provides a drive signal to energize CR motor 80 via drive circuit 81, thereby exercising control over the rotation of CR motor 80.

Drive circuit 81 drives CR motor 80 connected to carriage 38. In response to an output signal coming from ASIC 77, drive circuit 81 generates an electric signal for rotating CR motor 80. In response to receiving the electric signal, CR motor 80 starts rotating, and the rotational force of CR motor 80 is transmitted to carriage 38 via belt drive mechanism 46, so that carriage 38 moves back and forth. In this manner, control section 71 exercises control over the back-and-forth movement of carriage 38.

A drive circuit 82 serves to selectively discharge the inks onto a recording paper at any predetermined timing from recording head 39. Drive circuit 82 receives an output signal generated by ASIC 77 based on a drive control procedure provided by CPU 72, and exercises control over the driving of recording head 39.

ASIC 77 is connected with rotary encoder 83 for detecting the amount of rotation of transfer roller 67, and linear encoder 84 for detecting the movement amount of carriage 38. The ASIC 77 also is connected to scanner section 3, operation panel 6, slot section 7, a parallel interface (“parallel I/F”) 85, and a USB interface (“USB I/F”) 86, and other elements. Operation panel 6 issues commands to operate multi-function device 1, and slot section 7 is configured to receive various types of small-sized memory cards. Both parallel I/F 85 and USB I/F 86 control data transmission and reception to and from any external equipment, for example, to and from a personal computer via a parallel cable or a USB cable. ASIC 77 also is connected, for faxing, with a Network Control Unit (“NCU”) 87, a modem (“MODEM”) 88, and other elements.

As shown in FIG. 4, control section 71 comprises a main substrate (not shown), and a recording signal or others is transmitted via a flat cable 89 from the main substrate to recording head 39. Flat cable 89 may be a thin band formed by covering and insulating a conductor for electric signal transmission with a synthetic resin film, e.g., a polyester film. Flat cable 89 establishes an electrical connection between the main substrate and a control substrate (not shown) of the recording head 39. Flat cable 89 extends in the direction along which the carriage 38 moves back and forth, and is bent in the vertical direction and is substantially u-shaped. The substantially-U-shaped portion is not fixed to other components, and changes in shape as carriage 38 moves back and forth.

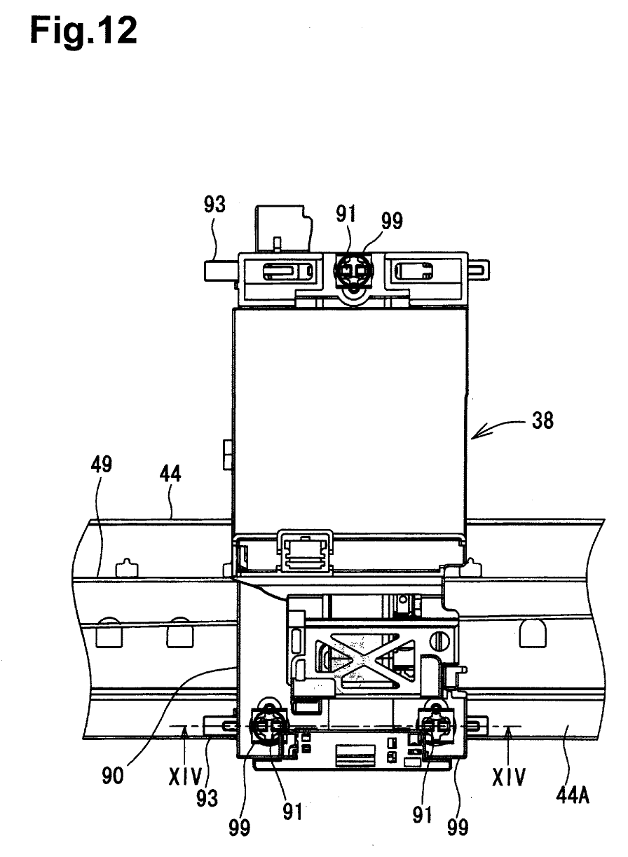

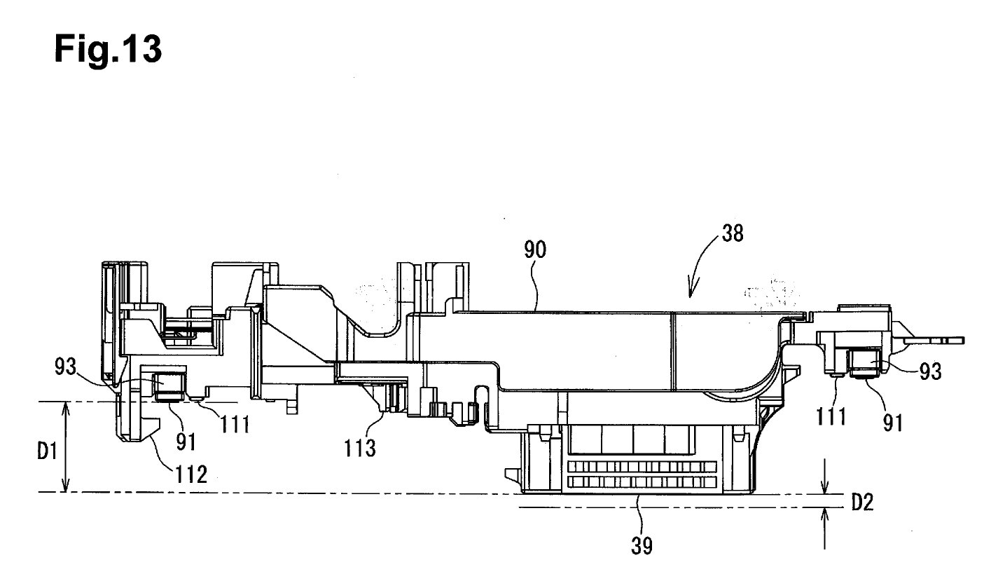

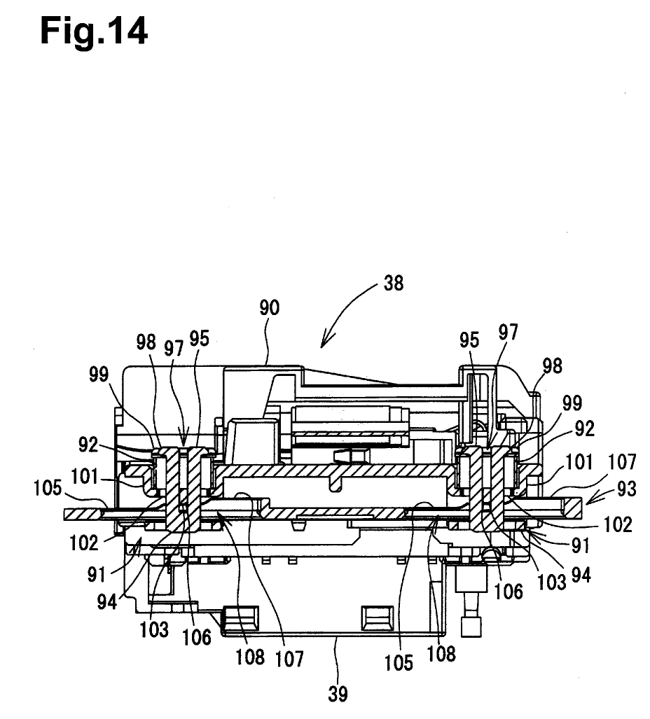

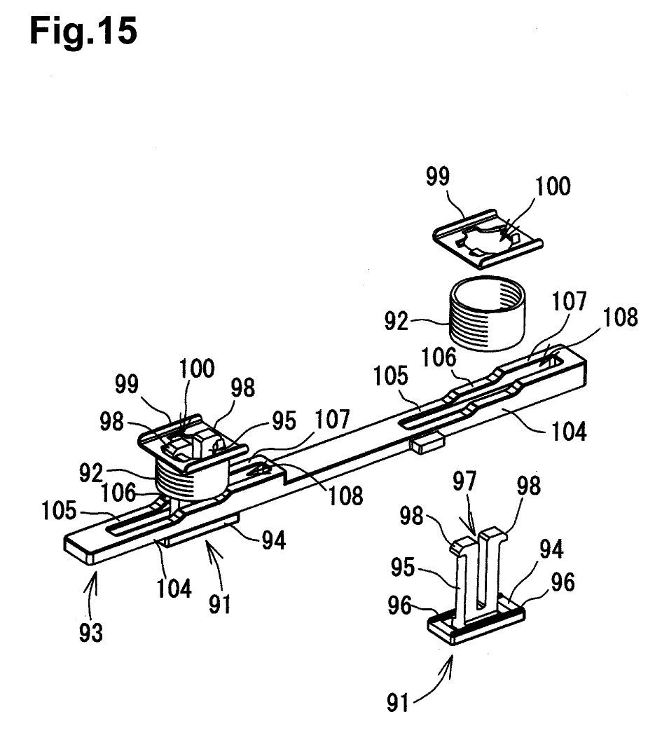

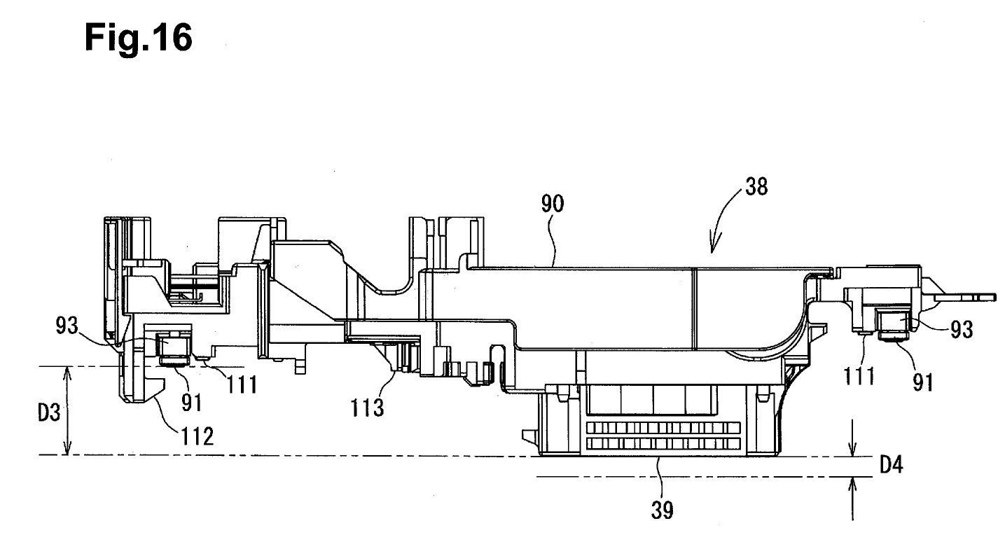

The configuration of carriage 38 is described in detail below. FIG. 12 is an enlarged plan view of carriage 38, showing the external configuration thereof. FIG. 13 is a right side view of carriage 38, and FIG. 14 is a cross-sectional view of carriage 38, along a line XIV-XIV. FIG. 15 is an exploded, perspective view of a slide member 91, a coil spring 92, and a gap adjustment member 93, showing their configurations. FIGS. 16 to 19 show the right side view and the cross-sectional view of carriage 38 in the condition in which gap adjustment member 93 slides. In FIG. 12, guide rail 43 is not shown, and in FIGS. 13 to 19, guide rails 43 to 44 are not shown.

As shown in FIGS. 12 to 14, carriage 38 comprises a carriage body 90, slide members 91, coil springs (biasing members) 92, and gap adjustment member 93. Carriage body 90 carries thereon recording head 39, and slide members 91 slide in contact with guide rails 43 and 44 and support carriage body 90 at a predetermined height. Coil springs 92 elastically bias upward slide members 91, and gap adjustment member 93 is disposed between carriage body 90 and slide members 91. The components of carriage body 90, i.e., slide member 91, coil spring 92, and gap adjustment member 93, are assembled on both sides of carriage body 90 in the paper-transfer direction corresponding to the orientation of guide rails 43 and 44. Because guide rails 43 and 44 share a similar configuration, the downstream side of the paper-transfer direction, i.e., the configuration on the side of guide rail 44, as described above.

As shown in FIG. 15, slide member 91 comprises a slide-contact plate 94, which slides in contact with guide rails 43 and 44, and a leg section 95, which extends from slide-contact plate 94. Slide-contact plate 94 is a substantially rectangular plate whose length in the shorter-side direction is substantially the same as that of gap adjustment member 93. The bottom surface of slide-contact plate 94 slides while in contact with guide surfaces 43A and 44A of guide rails 43 and 44, respectively. The upper surface of slide-contact plate 94 comprises a pair of convex portions 96 along the edge portions in the long-side direction. When the pair of convex portions 96 uniformly abut the bottom surface of gap adjustment member 93, the bottom surface of slide-contact plate 94 is positioned parallel to guide surfaces 43A and 44A of guide rails 43 and 44.

Leg section 95 extends from substantially the center of the upper surface of slide-contact plate 94 in a direction substantially orthogonal to the upper surface. Leg section 95 may be shaped like a plate extending longitudinally from slide-contact plate 94. A guide groove 97 formed through plate-like, leg section 95 extends along leg section 95. Guide groove 97 is open at an upper end of leg section 95, i.e., the upper side in FIG. 15. A support rib 103 of the carriage body 90 is inserted into guide groove 97, so that slide member 91 is supported movably along guide groove 97. Leg section 95 comprises a pair of latching sections 98 each of which is formed at either end of leg section 95 and which protrude outwardly in the longitudinal direction of slide-contact plate 94. As shown in FIG. 15, latching sections 98 secure slide-contact plate 94 to a stop plate 99. Stop plate 99 is formed with a through hole 100 there through to receive leg section 95. The width of the through hole 100 is less than the distance between the outer edges of each pair of latching sections 98. Latching sections 98 are formed on an elastic material, such that the distance between the outer edges of each pair of latching sections 98 may be changed by pressing the edges together to narrow the width of guide groove 97, e.g., by snap fitting latching sections 98 into through hole 100. Thus, when latching sections 98 are inserted into through hole 100 of stop plate 99, and when the pressing force applied to latching sections 98 is released, latching sections 98 elastically snap back into shape, thereby protruding from the circumferential edge of through hole 100. Slide-contact plate 94 may be secured to stop plate 99 by latching sections 98 to prevent leg section 95 from separating from through hole 100.

As shown in FIG. 14, a support member 101 is provided downstream of carriage body 90 in the paper-transfer direction and is separated from carriage 38 in its sliding direction, i.e., the lateral direction in FIG. 14. Support member 101 enables slide member 91 to move in the vertical direction. Support member 101 is the concave section whose internal diameter is slightly greater than the external diameter of coil spring 92. The bottom surface of the concave section is formed with a through hole 102 there through and comprises support rib 103. Through hole 102 receives leg section 95 of slide member 91, and support rib 103 is fitted to guide groove 97 of slide member 91. Because support rib 103 is fit into guide groove 97 of slide member 91, the slide member 91 is supported by the support member 101 and may move in the vertical direction along guide groove 97.

As shown in FIGS. 14 and 15, gap adjustment member 93 may be a flat plate-shaped like a slim and elongated rod, and is disposed between slide member 91 and support rib 103. Gap adjustment member 93 comprises a pair of adjustment portions 104, which are separated in the longitudinal direction. The thickness of adjustment portions 104, e.g., in the vertical direction in FIG. 14, may be adjusted between three levels in the direction along which gap adjustment member 93 slides. In particular, each of adjustment portions 104 comprises a thinnest section 105, a mid-thickness section 106, and a thickest section 107, which are disposed adjacent to each other to achieve a gradual increase in thickness in a predetermined direction. The upper surfaces of sections 105-107 are flat, and the length of the upper surfaces in the longitudinal direction is slightly greater than the width of leg section 95 of slide member 91. Each of the upper surfaces of the sections 105-107 is sloped at the section transition to achieve a gradual increase in thickness.

Each adjustment portion 104 is formed with an elongated hole 108 there through, which also passes through each of sections 105-107. Elongated holes 108 are formed substantially at the center of gap adjustment member 93 in the shorter-side direction. The width of elongated hole 108 in the shorter-side direction, is slightly greater than the thickness of leg section 95 of slide member 91, and leg section 95 passes through elongated hole 108. As shown in FIG. 14, after passing through elongated hole 108, the extended end of leg section 95 also passes through through hole 102 of support member 101 in carriage body 90. In this configuration, guide groove 97 of leg section 95 receives support rib 103. As shown in FIGS. 14 and 15, latching sections 98 of leg section 95 grasp stop plate 99.

Coil spring 92 is disposed between stop plate 99 and support member 101. Coil spring 92 applies an upward elastic biasing force to stop plate 99. The elastic biasing force acts on slide member 91 via the stop plate 99, and slide member 91 is elastically biased, so that support rib 103 is urged to the uppermost end of a range of movement allowed in the vertical direction. When gap adjustment member 93 is disposed between support rib 103 and slide-contact plate 94 of slide member 91, slide member 91 is urged downward against the elastic biasing force by the thickness of adjustment portion 104 of gap adjustment member 93. As described above, because adjustment portion 104 is formed with elongated hole 108 there through, gap adjustment member 93 may slide while leg section 95 of slide member 91 is inserted through elongated hole 108. With gap adjustment member 93 thus configured, adjustment portion 104 disposed between support ribs 103 and slide-contact plates 94 adjusts to vary thickness, and this variation in thickness accordingly raises slide member 91.

When leg section 95 is provided substantially at the center of slide-contact plate 94 of the slide member 91, and leg section 95 of slide member 91 is configured to pass through elongated hole 108 of gap adjustment member 93, the elastic biasing force of coil spring 92 acts substantially on the center of slide-contact plate 94. This biasing force stabilizes slide member 91 and gap adjustment member 93 by their position with respect to the elastic biasing force of coil spring 92. The elastic biasing force of coil spring 92 may be adjusted, such that the rotation moment is suppressed, and, thus, gap adjustment member 93 may slide. The rotation moment is generated when slide member 91 slides on the upper surfaces of guide rails 43 and 44.

Slide member 91 is oriented in the sliding direction of gap adjustment member 93 by support rib 103 disposed in guide groove 97 of leg section 95. Moreover, because leg section 95 is disposed through the elongated hole 108 of adjustment portion 104 of gap adjustment member 93, slide member 91 is disposed in the paper-transfer direction. Because slide-contact plate 94 abuts the bottom surface of gap adjustment member 93, the bottom surface, i.e., the slide-contact surface, of slide-contact plate 94 is disposed parallel to upper surfaces 43A and 44A of guide rails 43 and 44. Accordingly, twisting and rotation is reduced or eliminated even when slide member 91 moves in the vertical direction, and carriage 38 rests level with the surfaces of guide rails 43 and 44. Further, support rib 103 supports slide member 91, such that slide member 91 is movable in the vertical direction, and because support rib 103 abuts gap adjustment member 93, the gap switching mechanism for moving slide member 91 in the vertical direction allows a narrower range of movement back and forth for carriage 38. This gap switching mechanism sometimes is referred to as the load mechanism.

As shown in FIGS. 12 and 14, gap adjustment member 93 is disposed between slide member 91 and support rib 103, and gap adjustment member 93 has a sufficient length, such that the ends protruded beyond carriage body 90 in the sliding direction. Because these ends in the sliding direction abut abutment portions 109 and 110, as shown in FIG. 4, gap adjustment member 93 is raised. Abutment portions 109 and 110 are formed at the ends of guide rails 43 and 44. The multifunction device frame may be used as portions 109 and 110 abutment, or an abutment portion may be disposed at a predetermined position at the ends of guide rails 43 and 44. Various materials and shapes may be used to form abutment portions 109 and 110.

As shown in FIGS. 12 and 14, the gap switching mechanism may comprise slide member 91, coil spring 92, support member 101, and the gap adjustment member 93, which are disposed at both ends of carriage body 90 in the transfer direction, and the carriage body 90 further comprises support member 101 which supports slide member 91. As shown in FIG. 12, two slide members 91 are disposed with respect to carriage body 90 on the downstream side of the paper-transfer direction. Slide members 91 are configured to move in the vertical direction from the slide position of gap adjustment member 93. On the other hand, one slide member 91 is disposed with respect to carriage body 90 on the upstream side in the paper-transfer direction adjustment portion 104 is formed at the center of gap adjustment member 93 to move slide member 91 in the vertical direction.

There is a correlation between the height of slide member 91 retained by gap adjustment member 93 on the upstream side in the paper-transfer direction and that by gap adjustment member 93 on the downstream side in the paper-transfer direction. Consequently, when carriage 38 moves back and forth, the three slide members 91 keep carriage body 90 level, i.e., the height of slide member 91 on the upstream side of carriage body 90 is the same height of slide members 91 on the downstream side of carriage body 90, which are changed when the ends of the gap adjustment member 93 abut in the sliding direction. In particular, carriage 90 remains level with respect to upper surfaces 43A and 44A of guide rails 43 and 44, and recording head 39 mounted on the carriage body 90 also remains level, when carriage body 90 is moved in the vertical direction. Consequently, the gap between recording head 39 and the recording paper on platen 42 remain constant in the image recording area, so that image recording may be performed with a high degree of accuracy. The number of slide members 91 may vary. For example, two slide members 91 may also may be disposed on carriage body 90 on the upstream side in the paper-transfer direction, similar to the downstream side as described above.

As shown in FIG. 13, carriage body 90 comprises a support section 111, i.e., inward from slide members 91 on the upstream and downstream sides in the paper-recording direction. Each of support sections 111 protruding downward from the bottom surface of carriage body 90. When slide members 91 are inserted most deeply into carriage 90 with the most depth, support sections 111 respectively abut guide surfaces 43A and 44A of guide rails 43 and 44, so that carriage body 90 is defined by its height.

As shown in FIG. 13, carriage 90 comprises an L-shaped member 112 at the lower end of carriage body 90 on the downstream side in the paper-recording direction. L-shaped member 112 extends downward and is bent inward like a hook. When carriage 38 is disposed on guide rails 43 and 44, L-shaped member 112 is disposed on the lower surface side, and the hooked tip end is placed across the edge portion of guide rail 44. There is a predetermined space between the hooked tip end of L-shaped member 112 and the lower surface of guide rail 44. When carriage 38 moves upward from guide rail 44, the hooked tip end of L-shaped member 112 abuts the lower surface of guide rail 44, thereby preventing carriage 38 from moving further upward. Carriage 38 engages guide rail 44 with L-shaped member 112, permitting a predetermined degree of play in the vertical direction.

Control section 71 exercises control over the back-and-forth movement of carriage 38 which is configured to make gap adjustment member 93 abut abutment portions 109 and 110 at ends in the sliding direction.

As shown in FIG. 4, carriage 38, which carries thereon recording head 39, is disposed across guide rails 43 and 44, and control section 71 moves carriage 38 back and forth orthogonal to the paper-recording direction. When carriage 38 moves back and forth in response to a control signal generated by control section 71, recording head 39 selectively discharges ink droplets, so that a desired image is recorded on a recording paper passing over platen 42.

The carriage 38, which carries recording head 39, is supported at a predetermined height on guide surfaces 43A and 44A of guide rails 43 and 44 by support sections 111 of carriage body 90 or by slide members 91. This predetermined height is selected by control section 71 based on the thickness of the recording medium, e.g., a recording paper, an envelop, or others, and desired the resolution for the recording image. As described above, in the gap switching mechanism in this embodiment, the height of carriage 38 alternates between three levels depending on the thickness of adjustment portions 104 of gap adjustment member 93.

Control section 71 controls the movement of carriage 38 back and forth, and causes the ends of gap adjustment member 93 selectively abut abutment portions 109 and 110 formed at the ends of guide rails 43 and 44 in the sliding direction. Based on information, i.e., the thickness of a recording medium or the resolution of a recording image, coming from a printer driver or another source to multi-function device 1, control section 71 selects one of the three height levels for carriage 38. When the recording medium is a thick paper or an envelope, control section 71 generally increases the height of carriage 38 to move recording head 39 away from platen 42. When a high degree of resolution is desired for a recording image, ink droplets ejected from recording head 39 are reduced in size. Control section 71 thus reduces the height of carriage 38 to move recording head 39 closer to platen 42. Such requirements for height selection for the carriage 38 may be set in advance in consideration of the thickness of a recording medium or the desired resolution of a recording image, and are stored in ROM 73.

In this embodiment, as shown in FIGS. 13 and 14, the height of carriage 38 generally is set to the intermediate level of the three. With the height set at the intermediate level, mid-thickness section 106 of adjustment portion 104 of gap adjustment member 93 is located between support rib 103 and slide-contact plate 94 of slide member 91. In this state, as shown in FIG. 13, the lower surface of slide-contact plate 94 protrudes downward from support section 111 of carriage body 90, and carriage 38 remains at the intermediate height of the three by slide member 91. The distance from the lower surface of slide-contact plate 94, i.e., from guide surface 44A of guide rail 44, to the lower surface of recording head 39 is D1, and the distance from recording head 39 to the upper surface of platen 42 is D2. In FIGS. 13 to 19, guide rails 43 and 44 and platen 42 are not shown.

To increase the height of carriage 38, control section 71 rotates and drives CR motor 80 in a predetermined direction to move carriage 38 toward the side provided with purge mechanism 56, i.e., the right side in FIG. 4. When carriage 38 arrives directly above nozzle cap 152 and exhaust cap 153 after sliding on guide rails 43 and 44 toward the side of purge mechanism 56, nozzle cap 152 and exhaust cap 153 move upward and tightly attach to the lower surface of recording head 39. In response, carriage 38 moves slightly upward from guide rails 43 and 44. As described above, because carriage 38 is not separated completely from guide rail 44 due to L-shaped member 112, carriage 38 does not fall off guide rails 43 and 44.

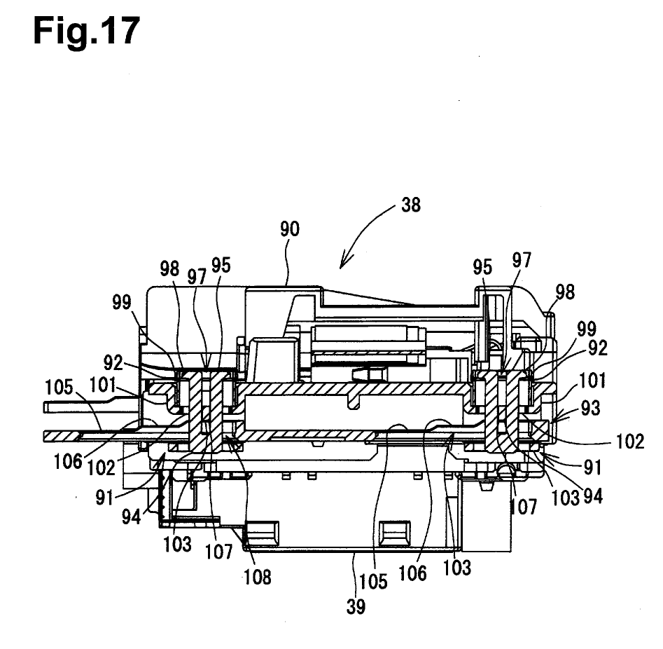

When carriage 38 moves onto nozzle cap 152 and exhaust cap 153, the end portion of gap adjustment member 93, which protrudes outward from carriage 38, abuts abutment portion 109. When carriage 38 moves further, such that one end portion of gap adjustment member 93, i.e., the right side in FIG. 4, abuts abutment portion 109, as shown in FIG. 17, gap adjustment member 93 moves sway from abutment portion 109, i.e., toward the left side of FIG. 17 with respect to carriage body 90. The slide position changes, such that one end portion of gap adjustment member 93 completely received into carriage body 90. As a result, thickest section 107 of adjustment portion 104 of gap adjustment member 93 comes between support rib 103 and slide-contact plate 94 of slide member 91. As shown in FIG. 16, the lower surface of slide-contact plate 94 protrudes downward from support section 111 of carriage body 90, and slide member 91 retains carriage 38 at the height highest of the three.

Gap adjustment member 93 slides in the direction to increase the distance between support rib 103 and slide-contact plate 94 against the elastic biasing force of coil spring 92 and the weight of carriage 38. This is due to the inertial force of carriage 38 moving back and force on guide rails 43 and 44 in response to a driving force coming from CR motor 80. As described above, through tight attachment of nozzle cap 152 and exhaust cap 153 to the lower surface of recording head 39, carriage 38 moves slightly upward from guide rails 43 and 44. Therefore, the weight of carriage 38 does not act when gap adjustment member 93 slides, and the torque required for CR motor 80 to slide gap adjustment member 93 is reduced.

The distance from the lower surface of slide-contact plate 94, i.e., from guide surface 44A of guide rail 44, to the lower surface of the recording head 39 is D3, and the distance from recording head 39 to the upper surface of platen 42 is D4. When a slide-contact member 86 protrudes downward further from carriage body 90, carriage 38 moves vertically above guide rails 43 and 44, and D1>D3. As a result, the lower surface of recording head 39 moves away from platen 42, and D2<D4. Accordingly this prevents, the recording medium from coming in contact with recording head 39 when a thick recording medium is transferred onto the platen 42. The change of the distance, i.e., gap, from recording head 39 to the recording medium as a result of a change in thickness of the recording medium is adjusted by the height of carriage 38.

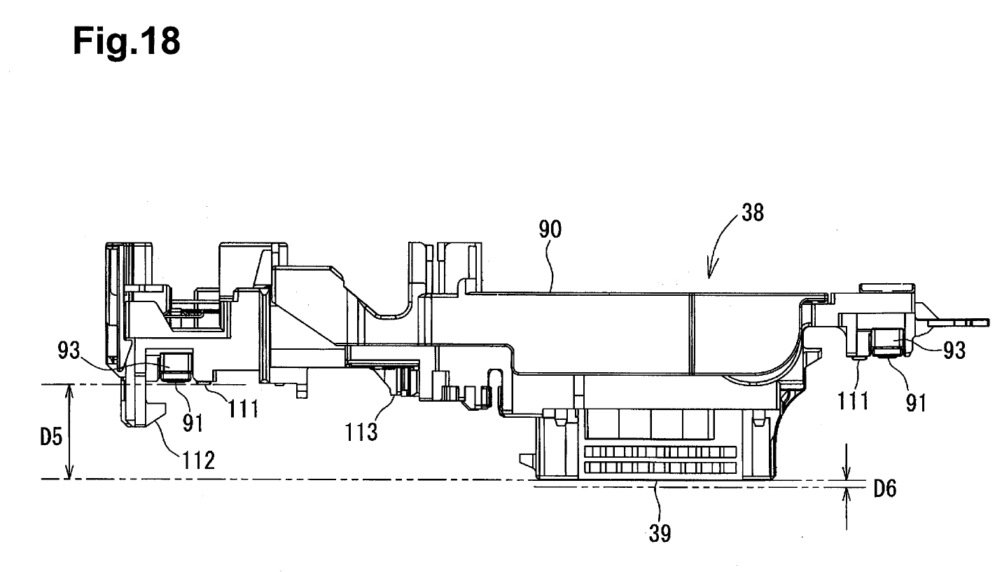

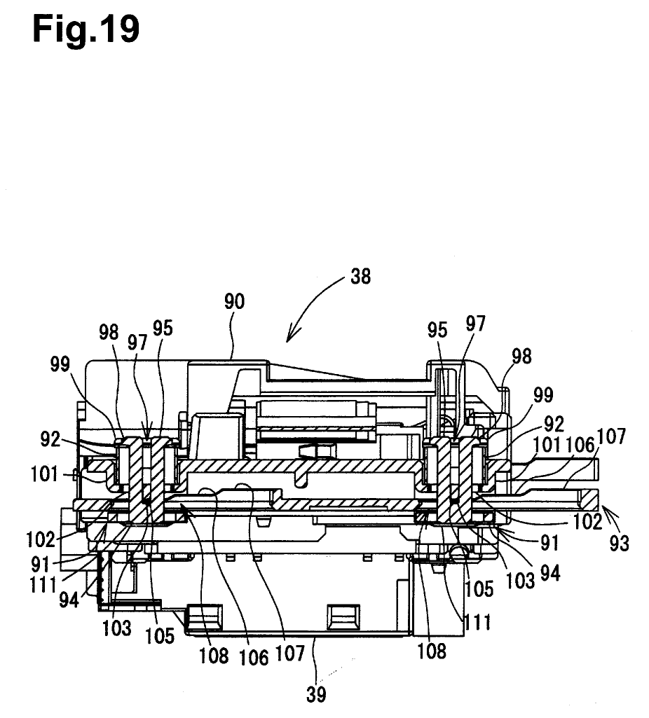

To reduce the height of carriage 38, control section 71 rotates and drives CR motor 80 in a predetermined direction to move carriage 38 toward the side provided with waste ink tray 57, i.e., the left side in FIG. 4. When carriage 38 is moved to the end portions of guide rails 43 and 44 after sliding on guide rails 43 and 44 toward the side of waste ink tray 57, the other end portion, i.e., the left side in FIG. 4, of gap adjustment member 93, which protrudes outwardly from carriage 38, abuts abutment portion 110. When the carriage 38 moves further, such that the other end portion of gap adjustment member 93 abuts abutment portion 110, as shown in FIG. 19, gap adjustment member 93 slides toward the right side of FIG. 19 with respect to carriage body 90. The slide position then changes, so that the other end portion of gap adjustment member 93 is received completely into carriage body 90. As a result, thinnest section 105 of adjustment portion 104 of gap adjustment member 93 comes between support rib 103 and slide-contact plate 94 of slide member 91. As shown in FIG. 18, in this state, the lower surface of slide-contact plate 94 protrudes upward from support section 111 of carriage body 90, and support section 111 retains carriage 38 at the height lowest of the three.

In this state, the distance from the lower surface of support section 111, i.e., from guide surface 44A of guide rail 44, to the lower surface of recording head 39 is D5, and the distance from recording head 39 to the upper surface of platen 42 is D6. Because slide-contact member 86 is received completely within the side of carriage body 90, carriage 38 moves directly below guide rails 43 and 44, and D1<D5. As a result, the lower surface of recording head 39 moves closer to platen 42, and D2>D6. This configuration is considered suitable for image recording with a high degree of resolution by recording head 39 discharging small ink droplets. In this embodiment, carriage 38 is supported on guide rails 43 and 44 by support section 111 of carriage body 90 when slide-contact member 86 is received completely within the side of carriage body 90. Alternatively, carriage body 90 may not include support section 111, and at any height, slide-contact member 86 may support carriage body 90 on guide rails 43 and 44.

The configuration of timing belt 49 now is described in detail.

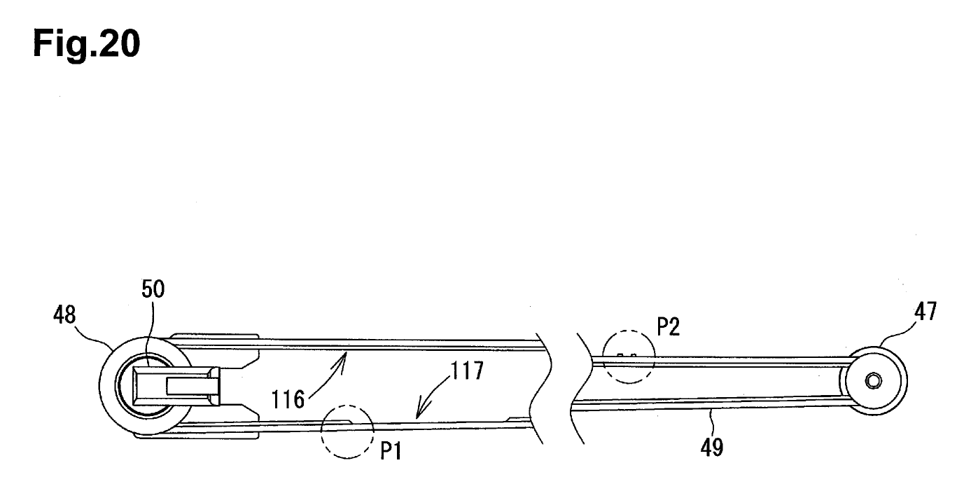

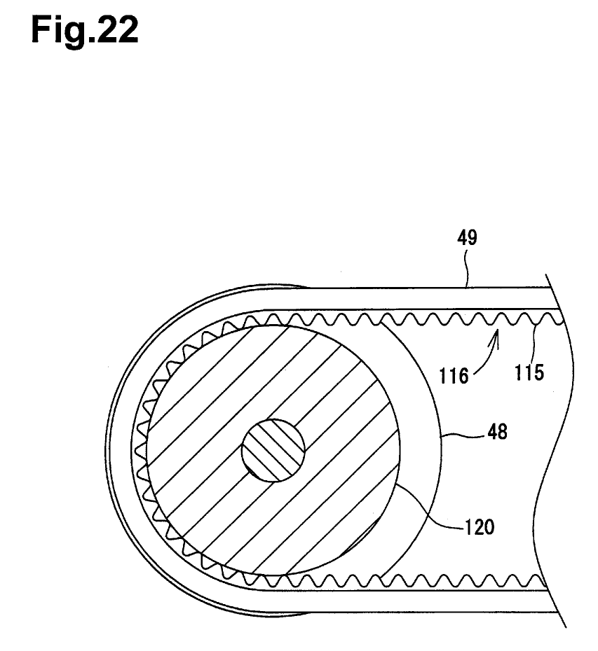

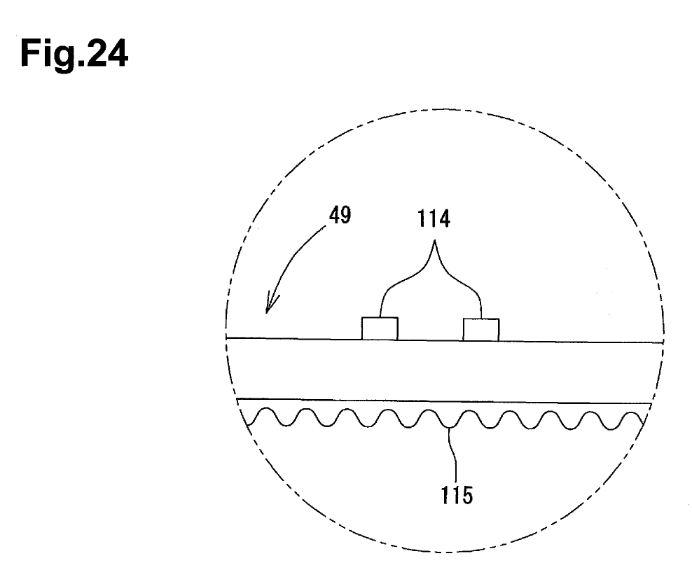

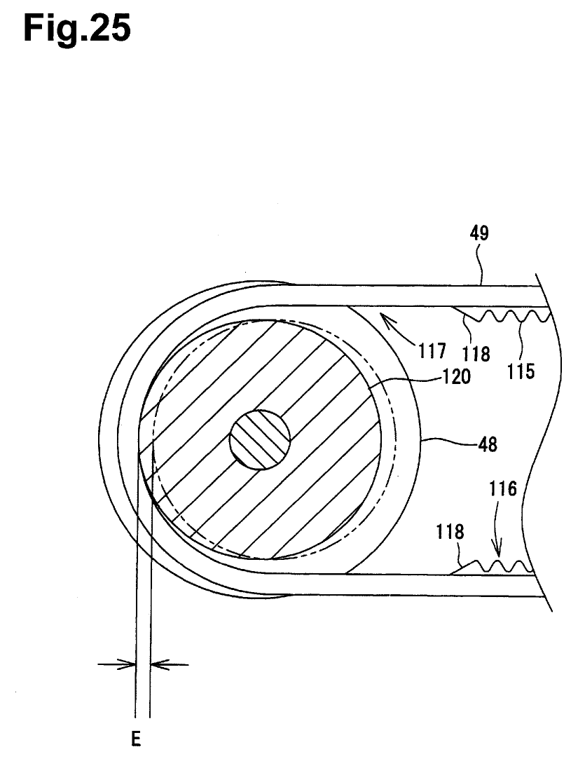

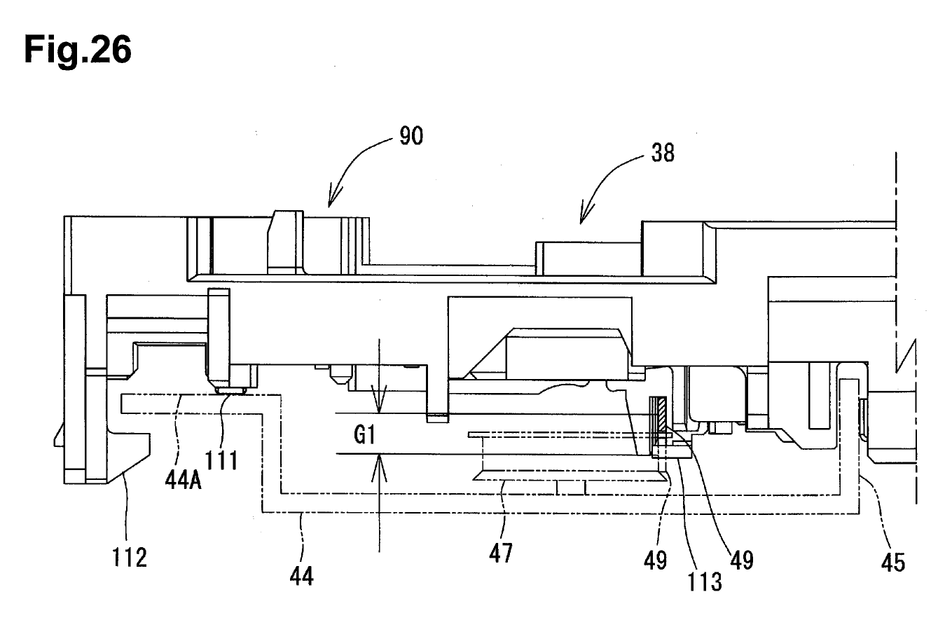

FIG. 20 is a plan view of timing belt 49 placed across drive and follower pulleys 47 and 48. FIG. 21 is a cross-sectional view of drive pulley 47 and timing belt 49, showing their meshing. FIG. 22 is a cross-sectional view of follower pulley 48, showing timing belt 49 wound about follower pulley 48. FIG. 23 is an enlarged plan view of a position P1 in FIG. 20, and FIG. 24 is an enlarged plan view of a position P2 in FIG. 20. FIG. 25 is a cross-sectional view of follower pulley 48, showing a toothless section 117 of timing belt 49 wound about follower pulley 48. FIG. 26 is a side view of carriage 38 and timing belt 49, showing their positional relationship. In FIG. 20, internal teeth 115 of timing belt 49 are not shown. In FIG. 26, guide rail 44 and drive pulley 47 are indicated by two-dotted lines, and gap adjustment member 93 and other components are not shown in carriage body 90.

Timing belt 49 may be an endless loop made of a polyurethane rubber resin, comprising glass-made core wire extending in the longitudinal direction. Referring to FIG. 23, timing belt 49 inner teeth 115 on the inner surface. As shown in FIG. 20, timing belt 49 comprises, a toothed section 116 and toothless section 117, e.g., a section of reduced thickness. Toothed section 116 comprises inner teeth 115, and toothless section 117 has a reduced thickness with no inner teeth 115 therein. Toothed section 116 comprises inner teeth 115 in a sequential manner. Because it is formed without inner teeth 115, toothless section 117 is thinner than the thickness of the area from the outer radius surface of timing belt 49 to the in dents of inner teeth 115. As shown in FIG. 23, timing belt 49 comprises a taper section 118 is formed at the boundary between toothed section 116 and toothless section 117, and tapered in thickness from thickness of the toothed section 116 to that of toothless section 117. Although FIG. 23 shows taper section 118 at one boundary between toothed section 116 and toothless section 117, taper section 118 also is formed at the other boundary.

As shown in FIG. 21, drive pulley 47 is a toothed pulley. Timing belt 49 winds around drive pulley 47, and inner teeth 115 of timing belt 49 mesh with spur teeth 119 of drive pulley 47. Through meshing between drive pulley 47 and timing belt 49, timing belt 49 moves circumferentially, without slipping, in response to the rotation drive of drive pulley 47. The driving force applied by drive pulley 47 to timing belt 49 is increased so that a greater torque may be generated to slide carriage 38.

As shown in FIG. 22, a pulley surface 120 of follower pulley 48 contains no spur teeth. Timing belt 49 winds around follower pulley 48 when the tip of the crest portions of inner teeth 115 come into contact with pulley surface 120. As shown in FIG. 5, follower pulley 48 pivots on pulley holder 50 and is biased elastically by coil spring 53 in the direction moving away from drive pulley 47. Timing belt 49 is with the elastic biasing force tensioned.

As shown in FIGS. 4 and 12, carriage 38 is mounted on guide rails 43 and 44 such that carriage 38 covers timing belt 49 of belt drive mechanism 46 on guide rail 44. The bottom surface of carriage body 90 opposes timing belt 49. As shown in FIG. 26, the bottom surface of carriage body 90 comprises a belt holder 113, i.e., belt coupling section formed therein for coupling carriage body 90 and timing belt 49.

Belt holder 113 is shaped like a slit extending in the direction along which carriage 38 moves back and forth, and the slit extends vertically upward form the lower side of the belt holder 113. The width of belt holder 113 is slightly less than the thickness of timing belt 49, and the depth thereof is greater than the width of timing belt 49. Timing belt 49 is placed across drive and follower pulleys 47 and 48 with the vertical direction being an axial direction. Therefore, between drive and follower pulleys 47 and 48, the width direction of timing belt 49 is the vertical direction, and the thickness direction thereof is the horizontal direction. Slit-shaped, belt holder 113 pinches timing belt 49 to sandwich timing belt 49 from above in the direction thickness. As such, timing belt 49 and carriage body 90 are coupled together via belt holder 113.

As shown in FIG. 24, timing belt 49 is formed with a pair of positioners 114 protruding outwardly from the outer circumferential surface. Each of positioners 114 serves as a mark indicating the position at which timing belt 49 is pinched by belt holder 113. Positioners 114 are disposed along the longitudinal direction of timing belt 49 at predetermined intervals, and each of the intervals is slightly larger than the width of belt holder 113. Belt holder 113 is coupled to pinch the area of the timing belt 49 between positioners 114. Consequently, carriage body 90 is coupled at a predetermined position of timing belt 49.

Each of Positioners 114 is formed at a position at which toothless section 117 of timing belt 49 winds around follower pulley 48 when carriage 38 is coupled to timing belt 49 and is disposed at a predetermined position within its range of movement back and forth. The predetermined position within the range back and forth movement by carriage 38 is outside of a recording area used by recording head 39, i.e., in this embodiment, outside of a recording area used by recording head 39 on the side of drive pulley 47. In other words, toothless section 117 of timing section 49 is within the range of back and forth movement by carriage 38, and not in a recording area used by recording head 39 on the side of drive pulley 47. This predetermined position also is a capping position for purge mechanism 56, and is a position at which gap adjustment member 93 of the gap switching mechanism abuts abutting portion 109.

As shown in FIG. 26, belt holder 113 of carriage body 90 is disposed above the position at which timing belt 49 winds on the side of drive pulley 47. Timing belt 49 thus is pinched by belt holder 113 as if being pulled upward from drive pulley 47. A height position difference between timing belt 49 on the side of drive pulley 47 and timing belt 49 in belt holder 113 is G1.

Because belt holder 113 pinches timing belt 49 with a height of the difference G1 from drive pulley 47, the tension of timing belt 49 acts on carriage body 90 via belt holder 113. Accordingly, biases this tension carriage body 90 toward the side of guide rail 44, thereby preventing carriage body 90 from moving upward from guide rail 44. As a result, the distance between the lower surface of recording head 39 and the upper surface of platen 42, i.e., the head gap, may remain.

When carriage 38 moves toward drive pulley 47, as compared with when carriage 38 is located substantially at the center of guide rail 44, the distance is shortened between drive pulley 47 and belt holder 113. Thus, timing belt 49 changes in height from drive pulley 47 to belt holder 113, i.e., corresponding to the difference G1, over a short distance, so that the slope angle of timing belt 49 increases.

As described above, when carriage 38 slides up to the vicinity of drive pulley 47, i.e., up to the position for capping by purge mechanism 56, as shown in FIG. 25, toothless section 117 of timing belt 49 winds around follower pulley 48. Because toothless section 117 is less thick than toothed section 116, when toothless section 117 winds around follower pulley 48, a thickness allowance E is created in the direction along which timing belt 49 is wound, i.e., the left side in FIG. 25. The thickness allowance E is equal to the reduced thickness of toothless section 117. As shown in FIG. 5, pulley holder 50 which supports follower pulley 48 is biased by coil spring 53 in the direction along which timing belt 49 is wound, i.e., the left side in FIGS. 5 and 25. Follower pulley 48 slides by the allowance E in the direction along which timing belt 49 is wound. Because pulley holder 50 slides together with follower pulley 48, coil spring 53 extends, so that the elastic biasing force weakens, and consequently, the tension of timing belt 49 reduces. In the vicinity of drive pulley 47, the downward biasing force applied to carriage body 90 by the tension of the timing belt 49 reduces.

As described above, when carriage 38 moves to the side of drive pulley 47, the slope angle of timing belt 49 increases between drive pulley 47 and belt holder 44A of the guide rail 44, to the lower surface of the recording head 39 is assumed as D3, and the distance from the recording head 39 to the upper surface of the platen 42 is assumed as D4. When a slide-contact member 86 protrudes downward to a further extent from the carriage body 90, the carriage 38 is moved vertically above the guide rails 43 and 44, and D1>D3 is established. As a result, the lower surface of the recording head 39 is moved away from the platen 42, and D2<D4 is established. This accordingly prevents, when a recording medium thick in thickness is transferred onto the platen 42, the recording medium from coming in contact with the recording head 39. The change of the distance, i.e., gap, from the recording head 39 to the recording medium as a result of the thick change of the recording medium is adjusted by the height of the carriage 38.

To reduce the height of the carriage 38, the control section 71 rotates and drives the CR motor 80 in a predetermined direction so as to move the carriage 38 toward the side provided with the waste ink tray 57, i.e., the left side in FIG. 4. When the carriage 38 is moved to the end portions of the guide rails 43 and 44 after sliding on the guide rails 43 and 44 toward the side of the waste ink tray 57, the other end portion, i.e., the left side in FIG. 4, of the gap adjustment member 93 having been protruded toward outside from the carriage 38 abuts the abutment portion 110. When the carriage 38 is moved to a further extent in the state that the other end portion of the gap adjustment member 93 is abutting the abutment portion 110, as shown in FIG. 19, the gap adjustment member 93 is made to slide toward the right side of FIG. 19 with respect to the carriage body 90. The slide position is then so changed that the other end portion of the gap adjustment member 93 is completely inserted into the carriage body 90. As a result, the thinnest section 105 of the adjustment portion 104 of the gap adjustment member 93 comes between the support rib 103 and the slide-contact plate 94 of the slide member 91. As shown in FIG. 18, in this state, the lower surface of the slide-contact plate 94 protrudes upward from the support section 111 of the carriage body 90, and the carriage 38 is kept at the height lowest of the three by the support section 111.

In this state, the distance from the lower surface of the support section 111, i.e., from the guide surface 44A of the guide rail 44, to the lower surface of the recording head 39 is assumed as D5, and the distance from the recording head 39 to the upper surface of the platen 42 is assumed as D6. Because the slide-contact member 86 being completely inserted into the side of the carriage body 90, the carriage 38 is moved directly below the guide rails 43 and 44, and D1<D5 is established. As a result, the lower surface of the recording head 39 is moved closer to the platen 42, and D2>D6 is established. This is considered suitable for image recording with a high resolution by the recording head 39 discharging small ink droplets. Note that, in this embodiment, the carriage 38 is supported on the guide rails 43 and 44 by the support section 111 of the carriage body 90 when the slide-contact member 86 is completely inserted into the side of the carriage body 90. Alternatively, the carriage body 90 may not be provided with the support section 111, and at any height, the slide-contact member 86 may support the carriage body 90 on the guide rails 43 and 44.

In the below, the configuration of the timing belt 49 is described in detail.

FIG. 20 is a plan view of the timing belt 49 placed across the drive and follower pulleys 47 and 48. FIG. 21 is a cross sectional view of the drive pulley 47 and the timing belt 49, showing their meshing. FIG. 22 is a cross sectional view of the follower pulley 48, showing the state of being wound with the timing belt 49. FIG. 23 is an enlarged plan view of a position P1 in FIG. 20, and FIG. 24 is an enlarged plan view of a position P2 in FIG. 20. FIG. 25 is a cross sectional view of the follower pulley 48, showing the state of being wound with a toothless section 117. FIG. 26 is a side view of the carriage 38 and that of the timing belt 49, showing their positional relationship. Note that, in FIG. 20, the internal tooth 115 of the timing belt 49 is not shown. In FIG. 26, the guide rail 44 and the drive pulley 47 are indicated by two-dotted lines, and the gap adjustment member 93 and others are not shown in the carriage body 90.

The timing belt 49 is an endless loop made of a polyurethane rubber resin, formed in such a way that a glass-made core wire extending in the longitudinal direction is included inside. The timing belt 49 is formed with, on the inner radius side, the inner tooth 115 (refer to FIG. 23). As shown in FIG. 20, the timing belt 49 includes, on the inner radius side, a toothed section 116 (section with teeth) and the toothless section 117 (material-thin section). The toothed section 116 is formed with the inner tooth 115, and the toothless section 117 is made thin with no inner tooth 115 formed. The toothed section 116 is formed with the inner tooth 115 in a sequential manner. As is not formed with the inner tooth 115, the toothless section 117 is made thinner than the thickness of the area from the outer radius surface of the timing belt 49 to the dents of the inner tooth 115. As shown in FIG. 23, at the border between the toothed section 116 and the toothless section 117, a taper section 118 is formed tapered in thickness in the range from the thickness of the toothed section 116 to that of the toothless section 117. Note that although FIG. 23 is showing the taper section 118 at one border between the toothed section 116 and the toothless section 117, the other border is also formed with the taper section 118.

As shown in FIG. 21, the drive pulley 47 is a toothed pulley. The timing belt 49 is wound around the drive pulley 47 by the inner tooth 115 being meshed with the spur tooth 119 of the drive pulley 47. Through meshing between the drive pulley 47 and the timing belt 49, the timing belt 49 is put in circumferential motion, without slipping, in response to the rotation drive of the drive pulley 47. The driving force coming from the drive pulley 47 to the timing belt 49 is increased so that the carriage 38 can be moved to slide with a larger torque.

As shown in FIG. 22, a pulley surface 120 of the follower pulley 48 is formed with no spur tooth. As such, the timing belt 49 is wound around the follower pulley 48 when the tip of the crest portions of the inner tooth 115 come in contact with the pulley surface 120. As shown in FIG. 5, the follower pulley 48 is pivoted by the pulley holder 50, and is elastically biased by the coil spring 53 in the direction moving away from the drive pulley 47. With the elastic biasing force, the timing belt 49 is provided with the tension.

As shown in FIGS. 4 and 12, the carriage 38 is mounted on the guide rails 43 and 44 in such a way that the timing belt 49 of the belt drive mechanism 46 on the guide rail 44 is covered thereby. The bottom surface of the carriage body 90 is thus opposing the timing belt 49. As shown in FIG. 26, for coupling between the carriage body 90 and the timing belt 49, the bottom surface side of the carriage body 90 is provided with a belt holder 113, i.e., belt coupling section.

The belt holder 113 is shaped like a slit extending in the direction along which the carriage 38 moves back and forth, and the depth direction of which is directed from the lower side of the belt holder 113 to vertically upward. The slit width of the belt holder 113 is slightly narrower than the thickness of the timing belt 49, and the slit depth thereof is deeper than the width of the timing belt 49. The timing belt 49 is placed across between the drive and follower pulleys 47 and 48 with the vertical direction being an axial direction. Therefore, between the drive and follower pulleys 47 and 48, the width direction of the timing belt 49 is the vertical direction, and the thickness direction thereof is the horizontal direction. The slit-shaped belt holder 113 pinches the timing belt 49 in such a posture to sandwich the belt from above toward the thickness direction. As such, the timing belt 49 and the carriage body 90 are coupled together via the belt holder 113.

As shown in FIG. 24, the timing belt 49 is formed with a pair of protrusion pieces 114 protruding toward outside from the outer circumferential surface. The protrusion pieces 114 each serve as a mark indicating the position where the timing belt 49 is supposed to be pinched by the belt holder 113. The protrusion pieces 114 are disposed along the longitudinal direction of the timing belt 49 at predetermined intervals, and the intervals are each slightly larger than the width of the belt holder 113. The belt holder 113 is coupled in such a way as to pinch the area of the timing belt 49 between the protrusion pieces 114. As such, the carriage body 90 is coupled at a predetermined position of the timing belt 49.

The protrusion pieces 114 are each formed at a position where the toothless section 117 of the timing belt 49 is wound around the follower pulley 48 when the carriage 38 coupled to the timing belt 49 is located at a predetermined position within its range to move back and forth. The predetermined position in the range for the carriage 38 to move back and forth is outside of a recording area for use by the recording head 39, i.e., in this embodiment, outside of a recording area for use by the recording head 39 on the side of the drive pulley 47. In other words, the toothless section 117 of the timing section 49 is within the range of the carriage 38 to move back and forth, and not in a recording area for use by the recording head 39 on the side of the drive pulley 47. Note that this predetermined position is a capping position for the purge mechanism 56, and also is a position where the gap adjustment member 93 of the gap switching mechanism abuts the abutting portion 109.

As shown in FIG. 26, the belt holder 113 of the carriage body 90 is located higher than the position where the timing belt 49 is wound on the side of the drive pulley 47. The timing belt 49 is thus pinched by the belt holder 113 as if being pulled upward from the drive pulley 47. Assumed here is that a height position difference between the timing belt 49 on the side of the drive pulley 47 and the timing belt 49 in the belt holder 113 is G1.

By the belt holder 113 pinching the timing belt 49 with a height of the difference G1 from the drive pulley 47, the tension of the timing belt 49 acts on the carriage body 90 via the belt holder 113. This accordingly biases the carriage body 90 toward the side of the guide rail 44, thereby preventing the carriage body 90 from moving upward from the guide rail 44. As a result, the distance between the lower surface of the recording head 39 and the upper surface of the platen 42, i.e., the head gap, can remain the same.

When the carriage 38 is moved to the side of the drive pulley 47, compared with a case where the carriage 38 is located substantially at the center of the guide rail 44, the distance is shortened from the drive pulley 47 to the belt holder 113. This means that the timing belt 49 changes in height from the drive pulley 47 to the belt holder 113, i.e., corresponding to the difference G1, with a short distance so that the slope angle of the timing belt 49 is increased.

As described in the foregoing, when the carriage 38 is moved to slide up to the vicinity of the drive pulley 47, i.e., up to the position for capping by the purge mechanism 56, as shown in FIG. 25, the toothless section 117 of the timing belt 49 is wound around the follower pulley 48. As the toothless section 117 is less thick compared with the toothed section 116, when the toothless section 117 is wound around the follower pulley 48, a thickness allowance E appears in the direction along which the timing belt 49 is placed, i.e., the left side in FIG. 25. The thickness allowance E here is equal to the thickness reduced by the toothless section 117. As shown in FIG. 5, the pulley holder 50 supporting the follower pulley 48 is biased by the coil spring 53 in the direction along which the timing belt 49 is placed, i.e., the left side in FIGS. 5 and 25. The follower pulley 48 is thus moved to slide in the direction by the allowance E in the direction along which the timing belt 49 is placed. By the pulley holder 50 moving to slide together with the follower pulley 48, the coil spring 53 is extended so that the elastic biasing force (spring force) is weakened, and by extension, the tension of the timing belt 49 is reduced. This means that, in the vicinity of the drive pulley 47, the downward biasing force is reduced for application to the carriage body 90 by the tension of the timing belt 49.

As described above, when the carriage 38 is moved to the side of the drive pulley 47, the slope angle of the timing belt 49 is increased from the drive pulley 47 to the belt holder 113. If toothless section 117 is not wound around follower pulley 48, the tension of timing belt 49 acting on belt holder 113 increases. More specifically, the vertical tension from timing belt 49 applied to carriage body 90 becomes strongest in the vicinity of drive pulley 47, and becomes weakest substantially at the center of guide rail 44.

Especially in the vicinity of drive pulley 47, carriage 38 is urged upward from guide rails 43 and 44 as a result of capping of the carriage 38 by purge mechanism 56. Therefore, in the vicinity of drive pulley 47, the vertical tension from timing belt 49 increases further. As shown in FIGS. 16 and 17, when gap adjustment member 93 slides, and when carriage 38 rises from guide rails 43 and 44, the vertical tension from timing belt 49 in the vicinity of drive pulley 47 increases further. Moreover, because spur teeth 119 of drive pulley 47 mesh with inner teeth 115 of timing belt 49, slippage timing belt 49 against drive pulley 47 is reduced or eliminated. Moreover, the tension of timing belt 49 is applied to carriage body 90 without being reduced. When the vertical biasing force applied by timing belt 49 to carriage 38 increases, carriage 38 is prevented from smoothly moving back and forth. This occurs because carriage 38 produces more friction when sliding in contact with guide rails 43 and 44.

Nevertheless, the tension of timing belt 49 weakens in the vicinity of drive pulley 47 when follower pulley 48 is wound with toothless section 117. This leads to a cancellation of forces, and, thus, the vertical tension applied by timing belt 49 to carriage body 90 is not increased too much in the vicinity of drive pulley 47. Thus, uneven abrasion of timing belt 49 in the vicinity of drive pulley 47 is reduced or eliminated. Moreover, because the friction resistance of carriage 38 is not increased with respect to guide rails 43 and 44 in the vicinity of drive pulley 47, the torque for CR motor 80 need not increase. In addition, this enables carriage 39 to move and slide up to the area in the vicinity of drive pulley 47, so that the size of multifunction devices using such timing belts may be reduced.

For such size reductions, when carriage 38 is located in the vicinity of drive pulley 47, toothless section 117 of timing belt 49 is wound around follower pulley 48. Nevertheless, as described above, the position at which belt holder 113 of carriage 38 is coupled comprises positioners 114. Thus, assemblers immediately may recognize where to couple belt holder 113, thereby facilitating the assembly operation. In this embodiment, each of Positioners 114 is a mark for indicating the coupling position. Alternatively, timing belt 49 may be partially colored or otherwise marked, or timing belt 49 may be changed in appearance, e.g., made uneven, to indicate the coupling position.

As described above, the taper section 118 may be disposed at a boundary between toothed section 116 and toothless section 117 of timing belt 49. At taper section 118, timing belt 49 gradually changes in thickness when toothless section 117 winds around follower pulley 48 or when toothed section 116 is wounded opposite to toothless section 117. This reduces the possibility of shock caused when timing belt 49 changes in thickness.

Exemplified in this embodiment is the situation in which carriage 38 moves to an area in the vicinity of drive pulley 47 to describe the reduction of the tension of timing belt 49. The embodiment, however, is not limited to such movement. When carriage 38 moves to the area in the vicinity of follower pulley 48, timing belt 49 is prevented from causing too much tension in the vicinity of follower pulley 48 with toothless section 117 formed similarly to timing belts 49.

In this embodiment, toothless section 117 is described as being an area in which inner teeth 115 of the timing belt 49 are not formed. Alternatively, the section of reduced thickness may be implemented by reducing the height of inner teeth 115 of timing belt 49. Still alternatively, the section of reduced thickness may be configured by reducing the thickness of timing belt 49 in addition to the configuration in which inner teeth 115 are not formed. The extent to which the thickness of the timing belt 49 is reduced in the section of reduced thickness is determined by the tension experienced by timing belt 49 in the vicinity of follower pulley 49.

In this embodiment, follower pulley 48 is elastically biased by coil spring 53 together with pulley holder 50 in the direction for applying tension to timing belt 49. In this embodiment, it is arbitrary whether follower pulley 48 is elastically biased or not. When follower pulley 48 is not elastically biased, timing belt 49 is loosened by the thickness reduced in toothless section 117, so that the tension is reduced.

In this embodiment, carriage 38 comprises with the gap switching mechanism which is configured to adjust, the height of carriage body 90 from guide rail 44 between three levels. In the carriage of the invention, it is arbitrary whether or not to include the gap switching mechanism. If the carriage is provided with the gap switching mechanism, the gap switching mechanism may take an other configuration.

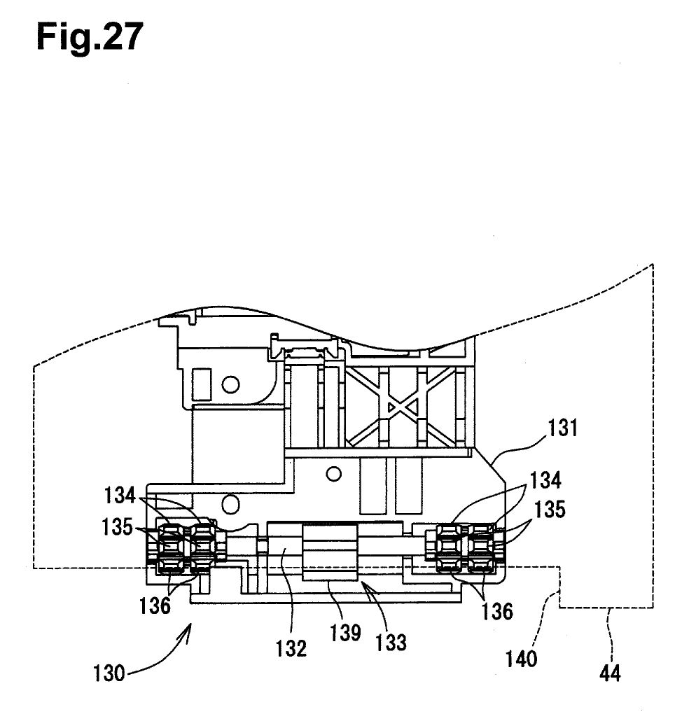

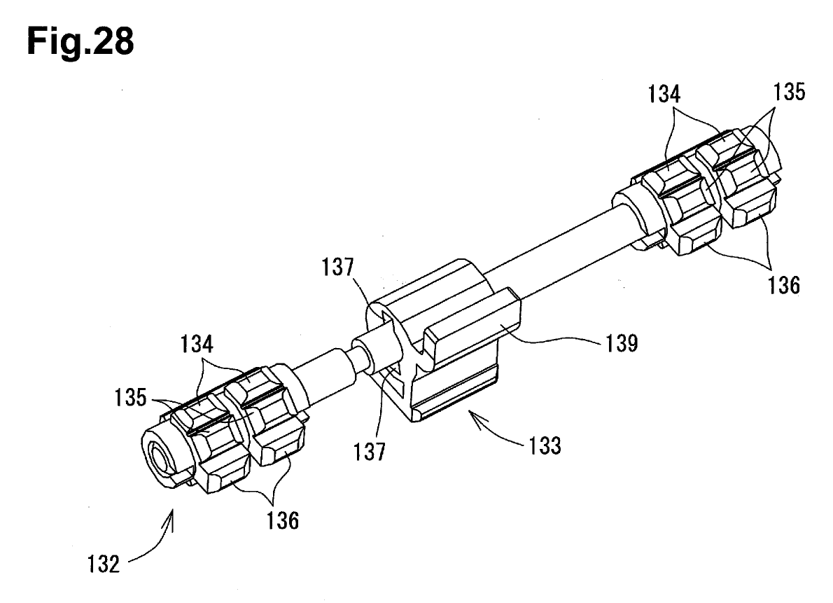

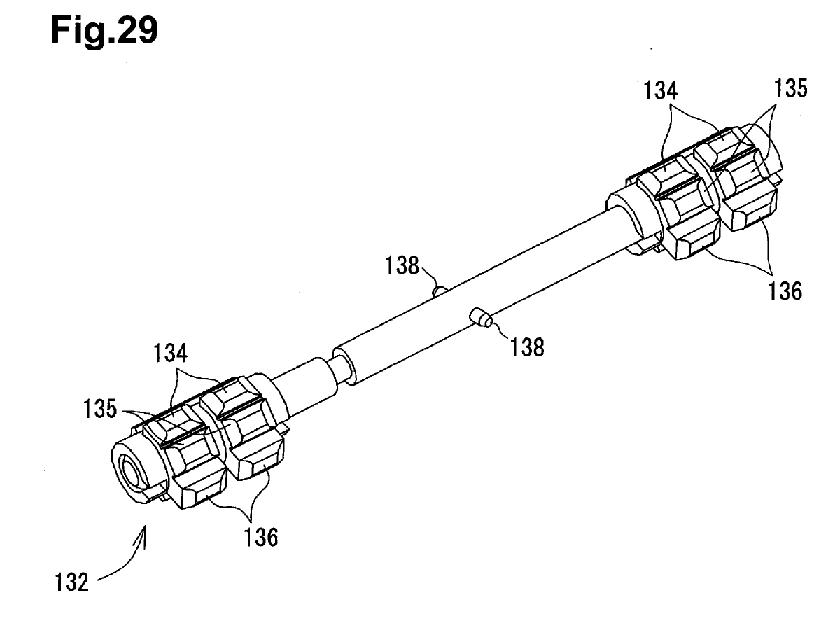

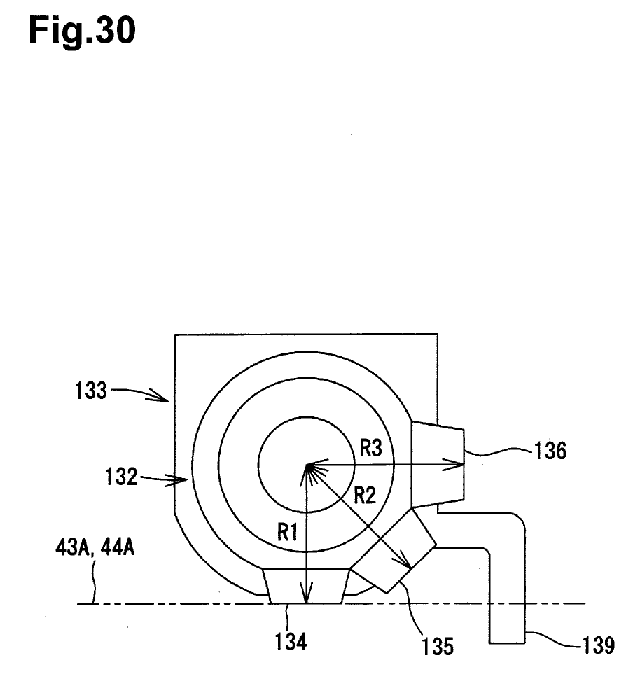

Another embodiment of a gap switching mechanism is described with respect to FIGS. 27-30. FIG. 27 is a partial bottom view of a carriage 130 according to another embodiment of the gap switching mechanism. FIG. 28 is a perspective view showing the external configurations of a rotation axle 132 and that of a slider 133. FIG. 29 is a perspective view showing the external configuration of the rotation axis 132. FIG. 30 is a side view of rotation axle 132 and that of slider 133. In FIG. 27, the upstream side of carriage 130 in the paper-transfer direction is not shown. Any component sharing the same reference numeral to the embodiments described above is the same.

As shown in FIG. 27, carriage 130 comprises a carriage body 131, rotation axle 132, and slider 133, i.e., input member. Carriage body 131 carries thereon recording head 39. Rotation axle 132 slides in contact with guide rails 43 and 44 and supports carriage body 131 at a predetermined height. Slider 133 is used to rotate rotation axle 132. Rotation axle 132 and slider 133 are disposed on both sides of carriage body 131 in the paper-transfer direction corresponding to guide rails 43 and 44. Because these share the similar configuration, the downstream side configuration in the paper-transfer direction is described below.

As shown in FIGS. 27 and 28, the axial length of rotation axle 132 is about the same as the width dimension, i.e., the lateral direction in FIG. 27, of carriage body 131. Rotation axle 132 is supported to freely rotate about its axis on the lower side surface of carriage body 131. The axis direction is parallel to the direction in which carriage 130 moves back and forth. Three types of slide-contact members 134, 135, and 136 are provided in pairs at each ends of rotation axle 132 in the axial direction. Each of slide-contact members 134, 135, and 136 is shaped like a block protruding outwardly from the circumferential surface of the rotation axle 132.

Each of slide-contact members 134, 135, and 136 has a different protrusion radius outward from rotation axle 132. The protrusion radius increases from slide-contact members 134 to 136. Slide-contact members 134, 135, and 136 are disposed sequentially in the circumferential direction at each end of rotation axle 132 in such a way that the protrusion radius shows a sequential change. Slide-contact members 134, 135, and 136 are disposed, such that the same type of the members, i.e., members with the same protrusion radius, correspond at the ends of rotation axle 132 in the circumferential direction.

As shown in FIG. 27, rotation axle 132 is supported by carriage body 131, such that any one of slide-contact members 134, 135, and 136 protrudes downwardly from carriage body 131. On the upstream and downstream sides of carriage body 131 in the paper-transfer direction, any of the slide-contact members 134, 135, and 136, which protrudes downwardly, provides level support from carriage body 131 on guide surfaces 43A and 44A of guide rails 43 and 44. Carriage 130 moves back and forth, as described in the foregoing embodiment, while making slide-contact members 134, 135, and 136 slide in contact with guide surfaces 43A and 44A of guide rails 43 and 44.

Slider 133 is externally fitted substantially at the center of the rotation axle 132 in the axial direction. Slider 133 is a tube-like member that is configured to slide in the axial direction along the outer circumferential surface of rotation axle 132. As shown in FIG. 28, slider 133 comprises a pair of engagement grooves 137 formed on the tube-like inner circumferential surface. Each of engagement grooves 137 is a helical structure, and are concave. As shown in FIG. 29, a pair of engagement convex sections 138 protrude from the outer circumferential surface toward outside substantially at the center in the axial direction of rotation axle 132. Engagement convex sections 138 are fitted respectively to engagement grooves 137, so that rotation axle 132 engages with slider 133. When slider 133 slides in the axial direction of the rotation axle 132, engagement convex sections 138 moves along engagement grooves 137, and as a result, the rotation axis 132 is rotated. In particular, the sliding force of slider 133 is transmitted as the rotation force of rotation axle 132 by engagement grooves 137 and engagement convex sections 138.

As shown in FIG. 28, the slider 133 comprises, an L-shaped protrusion piece 139 on the outer circumferential surface of slider 133 protruding outwardly. As shown in FIG. 27, when rotation axle 132 and slider 133 are assembled to carriage body 131, protrusion piece 139 protrudes from the lower surface carriage body 131. When carriage 130 slides to a predetermined position on guide rails 43 and 44, protrusion piece 139 abuts abutment portion 140. Abutment portion 140 is the one formed by partially cutting out guide rails 43 and 44. When carriage 130 slides, slider 133 slides in the axial direction of rotation axle 132.

Control section 71 exercises control over the back-and-forth movement of carriage 130 because protrusion piece 139 of slider 133 abuts abutment portion 140, and the rotational position of rotation axle 132 changes. Although FIG. 27 only shows abutment portion 140 disposed on one end side of guide rail 44, the other end of guide rail 44 another abutment portion 140 is disposed for abutment with the side opposite to protrusion piece 139 of slider 133. As shown in FIG. 30, when slide-contact member 134 having the shortest protrusion radius R1, i.e., the distance from the axial center of rotation axle 132 to the outer end surface, slides into contact with guide surfaces 43A and 44A of guide rails 43 and 44, carriage body 131 is supported at the lowest height among the three levels.

In response to control signals from control section 71, carriage 130 slides on guide rails 43 and 44 in a predetermined direction, and slider 133 abuts abutment portions 140 formed to guide rails 43 and 44. Slider 133 arbitrarily slides in the axial direction of rotation axle 132. The sliding force of slider 133 is transmitted as a rotation force to rotation axle 132, so that rotation axle 132 rotates. Such force transmission is made by engagement grooves 137 and engagement convex sections 138. As such, by sliding slider 133 and rotating rotation axle 132 in such a manner that slide-contact member 135 slides into contact with guide surfaces 43A and 44A of guide rails 43 and 44, carriage 130 is supported at the intermediate level among the three levels. Thus, carriage 130 is supported at a height based on the protrusion radius R2, i.e., the distance from the axial center of rotation axle 132 to the outer end surface of slide-contact member 135. Similarly, by sliding slider 133 and rotating rotation axle 132 in such a manner that slide-contact member 136 slides into contact with guide surfaces 43A and 44A of guide rails 43 and 44, carriage 130 is supported at the highest level among the three levels. Therefore, carriage 130 is supported at a height based on the protrusion radius R3, i.e., the distance from the axial center of rotation axle 132 to the outer end surface of slide-contact member 136. This enables the adjustment of the gap between recording head 39 and a recording medium based on the thickness of the recording medium. With such a configuration of this modified example, the gap switching mechanism, i.e., load mechanism, of the invention also may be implemented.

While the invention has been described in connection with exemplary embodiments, it will be understood by those skilled in the art that other variations and modifications of the exemplary embodiments described above may be made without departing from the scope of the invention. Other embodiments will be apparent to those skilled in the art from a consideration of the specification or practice of the invention disclosed herein. It is intended that the specification and the described examples are considered merely as exemplary of the invention, with the true scope of the invention being indicated by the flowing claims.

What is claimed is:

1. A carriage transiting device comprising:
at least one guide rail, each comprising a first end and a second end and extending in a predetermined direction from the first end to the second end;
a carriage comprising a carriage body and mounted on the at least one guide rail;
a recording head mounted on the carriage body;
and a belt drive mechanism disposed along one of the at least one guide rail to move the carriage back and forth along the at least one guide rail,
wherein the belt drive mechanism comprises:
a drive pulley disposed proximate to the first end of the at least one guide rail that is rotated by a driving force generated by a drive source and comprising a plurality of spur teeth;
a follower pulley disposed proximate to the second end of the guide surface and separate from the drive pulley in the predetermined direction; and
a belt disposed about the drive pulley and the follower pulley, such that the belt moves circumferentially when the drive pulley rotates, and comprising a section of reduced thickness, which section of reduced thickness engages the follower pulley while the carriage moves back and forth over the at least one guide rail, and a plurality of belt teeth, wherein the plurality of belt teeth are disposed outside of the section of reduced thickness and are configured to mesh with the plurality of spur teeth.

2. The carriage transiting device according to claim 1, the belt further comprising a tapered section, wherein the tapered section is disposed at a border between plurality of belt teeth and the section of reduced thickness.

3. The carriage transiting device according to claim 1, further comprising a load mechanism that imposes a load on the carriage in a direction away from the at least one guide rail when the drive pulley rotates and the carriage is located proximate to the drive pulley and while the carriage moves back and forth over the at least one guide rail.

4. The carriage transiting device according to claim 3, further comprising a cap configured to contact the recording head and the load mechanism further comprising a capping mechanism that presses the cap to achieve tight contact with the recording head.

5. The carriage transiting device according to claim 3, the load mechanism further comprising a gap switching mechanism configured to adjust a height of the carriage with respect to the at least one guide rail.

6. The carriage transiting device according to claim 5, the gap switching mechanism is disposed on the carriage body and further comprises:
a slide member configured to slide on the at least one guide rail and to support the carriage body at a predetermined height;
a support member of the carriage body configured to urge the slide member away from the guide surface;
a biasing member elastically biasing the slide member away from the at least one guide rail; and
a gap adjustment member disposed between the slide member and the support member to slide along with the carriage as the carriage moves back and forth, which protrudes beyond the carriage body at the first and second end of the carriage to adjust a separation between the slide member and the support member in response to the carriage position.

7. The carriage transiting device according to claim 5, wherein the gap switching mechanism is disposed on the carriage body and further comprises a rotation axle configured to rotate freely to adjust the carriage body to a predetermined height above the at least one guide rail and the rotation axle further comprising a plurality of sliding contact members disposed about the circumference of the rotation axle, wherein each of the sliding contact members extends a predetermined protrusion radius from a central axis of the rotation axle configured to contact with the at least one guide rail and a protrusion configured to rotate the rotation axle and shift the position of the plurality of sliding contact members.

8. The carriage transiting device according to claim 1, further comprising a follower pulley biasing means to position the follower pulley and to increase the separation between the follower pulley and the drive pulley.

9. The carriage transiting device according to claim 1, the carriage further comprising a belt coupling section and wherein the belt further comprises a mark disposed at a position at which the belt coupling section of the carriage is coupled to the belt.

10. A carriage transiting device comprising:
at least one guide rail, each comprising a first end and a second end and extending in a predetermined direction from the first end to the second end;
a carriage comprising a carriage body and mounted on the at least one guide rail;
a recording head mounted on the carriage body;
and a belt drive mechanism disposed along one of the at least one guide rail to move the carriage back and forth along the at least one guide rail,
wherein the belt drive mechanism comprises:
a drive pulley disposed proximate to the first end of the at least one guide rail that is rotated by a driving force generated by a drive source and comprising a plurality of spur teeth;
a follower pulley disposed proximate to the second end of the at least one guide rail and separate from the drive pulley in the predetermined direction; and
a belt disposed about the drive pulley and the follower pulley, such that the belt moves circumferentially when the drive pulley rotates, and comprising a section of reduced thickness, which section of reduced thickness engages the follower pulley while the carriage moves back and forth over the at least one guide rail, and a plurality of belt teeth, wherein a first average height of the belt teeth disposed outside of the section of reduced thickness is greater than a second average height of the belt teeth disposed within the section of reduced thickness and wherein the plurality of belt teeth are configured to mesh with the plurality of spur teeth.

11. The carriage transiting device according to claim 10, the belt further comprising a tapered section, wherein the tapered section is disposed at a border between plurality of belt teeth and the section of reduced thickness.

12. The carriage transiting device according to claim 10, further comprising a load mechanism that imposes a load on the carriage in a direction away from the at least one guide rail when the drive pulley rotates and the carriage is located proximate to the drive pulley and while the carriage moves back and forth over the at least one guide rail.

13. The carriage transiting device according to claim 12, further comprising a cap configured to contact the recording head and the load mechanism further comprising a capping mechanism that presses the cap to achieve tight contact with the recording head.

14. The carriage transiting device according to claim 12, the load mechanism further comprising a gap switching mechanism configured to adjust a height of the carriage with respect to the at least one guide rail.

15. The carriage transiting device according to claim 14, the gap switching mechanism is disposed on the carriage body and further comprises:
a slide member configured to slide on the at least one guide rail and to support the carriage body at a predetermined height;
a support member of the carriage body configured to urge the slide member away from the at least one guide rail;
a biasing member elastically biasing the slide member away from the at least one guide rail; and
a gap adjustment member disposed between the slide member and the support member to slide along with the carriage as the carriage moves back and forth, which protrudes beyond the carriage body at the first and second end of the carriage to adjust a separation between the slide member and the support member in response to the carriage position.

16. The carriage transiting device according to claim 14, wherein the gap switching mechanism is disposed on the carriage body and further comprises a rotation axle configured to rotate freely to adjust the carriage body to a predetermined height above the at least one guide rail and the rotation axle further comprising a plurality of sliding contact members disposed about the circumference of the rotation axle, wherein each of the sliding contact members extends a predetermined protrusion radius from a central axis of the rotation axle configured to contact with the at least one guide rail and a protrusion configured to rotate the rotation axle and shift the position of the plurality of sliding contact members.

17. The carriage transiting device according to claim 10, further comprising a follower pulley biasing means to position the follower pulley and to increase the separation between the follower pulley and the drive pulley.

18. The carriage transiting device according to claim 10, the carriage further comprising a belt coupling section and wherein the belt further comprises a mark disposed at a position at which the belt coupling section of the carriage is coupled to the belt.

19. A carriage transiting device comprising:
at least one guide rail, each comprising a first end and a second end and extending in a predetermined direction from the first end to the second end;
a carriage comprising a carriage body and mounted on the at least one guide rail;
a recording head mounted on the carriage body;
a load mechanism that imposes a load on the carriage in a direction away from the at least one guide rail when the drive pulley rotates and the carriage is located proximate to the drive pulley and while the carriage moves back and forth over the at least one guide rail; and
a belt drive mechanism disposed along the at least one guide rail to move the carriage back and forth along the at least one guide rail,
wherein the belt drive mechanism comprises:
a drive pulley disposed proximate to the first end of the guide surface that is rotated by a driving force generated by a drive source and comprising a plurality of spur teeth;
a follower pulley disposed proximate to the second end of the guide surface and separate from the drive pulley in the predetermined direction; and
a belt disposed about the drive pulley and the follower pulley, such that the belt moves circumferentially when the drive pulley rotates.

20. The carriage transiting device according to claim 19, further comprising a cap configured to contact the recording head and the load mechanism further comprising a capping mechanism that presses the cap to achieve tight contact with the recording head.

21. The carriage transiting device according to claim 20, the load mechanism further comprising a gap switching mechanism configured to adjust a height of the carriage with respect to the at least one guide rail.

22. The carriage transiting device according to claim 21, the gap switching mechanism is disposed on the carriage body and further comprises:
a slide member configured to slide on the at least one guide rail and to support the carriage body at a predetermined height;
a support member of the carriage body configured to urge the slide member away from the at least one guide rail;
a biasing member elastically biasing the slide member away from the at least one guide rail; and
a gap adjustment member disposed between the slide member and the support member to slide along with the carriage as the carriage moves back and forth, which protrudes beyond the carriage body at the first and second end of the carriage to adjust a separation between the slide member and the support member in response to the carriage position.

23. The carriage transiting device according to claim 22, wherein the gap switching mechanism is disposed on the carriage body and further comprises a rotation axle configured to rotate freely to adjust the carriage body to a predetermined height above the at least one guide rail and the rotation axle further comprising a plurality of sliding contact members disposed about the circumference of the rotation axle, wherein each of the sliding contact members extends a predetermined protrusion radius from a central axis of the rotation axle configured to contact with the at least one guide rail and a protrusion configured to rotate the rotation axle and shift the position of the plurality of sliding contact members.

24. The carriage transiting device according to claim 19, further comprising a follower pulley biasing means to position the follower pulley and to increase the separation between the follower pulley and the drive pulley.

25. The carriage transiting device according to claim 19, the carriage further comprising a belt coupling section and wherein the belt further comprises a mark disposed at a position at which the belt coupling section of the carriage is coupled to the belt.

26. The carriage transiting device according to claim 19, the drive pulley further comprising a plurality of spur teeth, and the belt further comprising a plurality of belt teeth, wherein the plurality of belt teeth are disposed outside of the section of reduced thickness and are configured to mesh with the plurality of spur teeth.

27. The carriage transiting device according to claim 19, the drive pulley further comprising a plurality of drive pulley teeth, and the belt further comprising a plurality of belt teeth, wherein a first height of each of the belt teeth disposed outside of the section of reduced thickness is greater than a second height of each of the belt teeth disposed within the section of reduced thickness and wherein the plurality of belt teeth are configured to mesh with the plurality of drive pulley teeth.

28. An image formation device comprising a cartridge transiting device according to claim 1.

29. An image formation device comprising a cartridge transiting device according to claim 10.

30. An image formation device comprising a cartridge transiting device according to claim 19.
